(19) United States
(12) Patent Application Publication
(10) Pub. No.: US 2024/0078411 A1
(43) Pub. Date: Mar. 7, 2024

(54) INFORMATION PROCESSING SYSTEM, ENCODING DEVICE, DECODING DEVICE, MODEL LEARNING DEVICE, INFORMATION PROCESSING METHOD, ENCODING METHOD, DECODING METHOD, MODEL LEARNING METHOD, AND PROGRAM STORAGE MEDIUM

(71) Applicant: NEC Corporation, Minato-ku, Tokyo (JP)

(72) Inventors: Florian BEYE, Tokyo (JP); Hayato ITSUMI, Tokyo (JP); Yusuke SHINOHARA, Tokyo (JP); Charvi VITTHAL, Tokyo (JP); Koichi NIHEI, Tokyo (JP); Takanori IWAI, Tokyo (JP)

(73) Assignee: NEC Corporation, Minato-ku, Tokyo (JP)

(21) Appl. No.: 18/280,391

(22) PCT Filed: Mar. 9, 2021
(86) PCT No.: PCT/JP2021/009205

§ 371 Date: Sep. 5, 2023

(51) Int. Cl. G06N 3/0455

(52) U.S. Cl. CPC G06N 3/0455

(57) ABSTRACT

A first distribution estimating device determines a first probability distribution of quantized values in a predetermined value range corresponding to an input value, by using a first machine learning model. A first sampling device samples the quantized values and determines a first sample value, using the first probability distribution. A second distribution estimating device determines a second probability distribution corresponding to the first sample value, by using a second machine learning model. A second sampling device samples the quantized values in the value range and determines a second sample value, using the second probability distribution. It can be implemented in the form of any of an information processing system, an encoding device, a decoding device, a model learning device, an information processing method, an encoding method, a decoding method, a model learning method, and a program storage medium.

### TECHNICAL FIELD

The present invention relates to an information processing system, an encoding device, a decoding device, a model learning device, an information processing method, an encoding method, a decoding method, a model learning method, and a program storage medium.

### BACKGROUND ART

Non-Patent Document 1 discloses lossy image compression using an auto-encoder. Such an auto-encoder includes an encoder and a decoder. Image data is input to the encoder, and a code sequence output from the encoder is input to the decoder. The decoder outputs reconstructed image data based on the code sequence. The encoder and the decoder each use a convolutional neural network (CNN) and are configured as a probabilistic model in a feature amount space. Each code forming a code sequence represents a quantized feature amount. The characteristics of a probabilistic model are represented by parameters for giving the probability distribution of image feature amounts. The bit rate of a code sequence depends on the probability distribution. The parameter set for the auto-encoder is updated so that the loss function that is dependent on the information amount is minimized.

### CITATION LIST

### Patent Literature

[Non Patent Document 1] L. Theis, W. Shi, A. Cunningham, and F. Huszar, “Lossy Image Compression with Compressive Autoencoders”, International Conference on Learning Representations, 2017 (ICLR 2017), Apr. 23-25, 2017

### SUMMARY OF THE INVENTION

### Problems to be solved by the Invention

In the learning of a machine learning model parameter set, when calculating the update amount of a parameter set for a loss function, a differential value based on an image feature amount may be used. However, in the auto-encoder disclosed in Non Patent Document 1, the image feature amount is quantized. The loss function cannot be differentiated by a quantized image feature amount, which is an image feature amount after quantization. Accordingly, the differential value of the quantized image feature amount with respect to the image feature amount before quantization was assumed to be 1. Therefore, the parameter set obtained by learning does not necessarily converge to an optimum solution, and this has caused deterioration in the quality of the reconstructed image represented by the reconstructed image data. On the other hand, depending on the intended use of the reconstructed image, a faithful reproduction of the original image may not be required as long as the required quality is obtained under a certain loss function.

An exemplary object of the present invention is to provide an information processing system, an encoding device, a decoding device, a model learning device, an information processing method, an encoding method, a decoding method, a model learning method, and a program storage medium.

### Means for Solving the Problems

According to a first exemplary aspect, an information processing system includes: a first distribution estimation device that determines a first probability distribution of quantized values in a predetermined value range corresponding to an input value, by using a first machine learning model; a first sampling device that samples the quantized values and determines a first sample value, using the first probability distribution; a second distribution estimation device that determines a second probability distribution corresponding to the first sample value, by using a second machine learning model; and a second sampling device that samples the quantized values in the value range and determines a second sample value, using the second probability distribution.

According to a second exemplary aspect, an encoding device includes: a distribution estimation device that determines a probability distribution of quantized values in a predetermined value range corresponding to an input value, by using a machine learning model; a sampling device that samples the quantized values and determines a sample value, using the probability distribution; and an entropy encoding device that entropy-encodes a sample value sequence including a plurality of the sample values to generate a code sequence.

According to a third exemplary aspect, a decoding device includes: an entropy decoding device that entropy-decodes a code sequence to generate a sample value sequence including a plurality of sample values; a distribution estimation device that determines a probability distribution corresponding to the sample values, by using a machine learning model; and a sampling device that samples quantized values in a predetermined value range and determines a sample value, using the probability distribution.

According to a fourth exemplary aspect, a model learning device includes a model learning device that determines parameters for a first machine learning model and parameters for a second machine learning model, so as to further reduce a combined loss function obtained by combining a first factor based on an information amount of a first sample value, and a second factor based on a difference between an input value and a second sample value, wherein the first sample value is determined by using a first probability distribution to sample quantized values in a predetermined value range, the second sample value is determined by using a second probability distribution to sample quantized values in the predetermined value range, the first machine learning model is used to determine the first probability distribution of quantized values in a predetermined value range corresponding to the input value, and the second machine learning model is used to determine the second probability distribution corresponding to the first sample value.

According to a fifth exemplary aspect, an information processing method in an information processing system includes: a first distribution estimation step of determining a first probability distribution of quantized values in a predetermined value range corresponding to an input value, by using a first machine learning model; a first sampling step of sampling the quantized values and determining a first sample value, using the first probability distribution; a second distribution estimation step of determining a second probability distribution corresponding to the first sample value, by using a second machine learning model; and a second sampling step of sampling the quantized values in the value range and determining a second sample value, using the second probability distribution.

According to a sixth exemplary aspect, an encoding method in an encoding device includes: a first step of determining a probability distribution of quantized values in a predetermined value range corresponding to an input value, by using a machine learning model; a second step of sampling the quantized values and determining a sample value, using the probability distribution; and a third step of entropy-encoding a sample value sequence including a plurality of the sample values to generate a code sequence.

According to a seventh exemplary aspect, a decoding method in a decoding device includes: a first step of entropy-decoding a code sequence to generate a sample value sequence including a plurality of sample values; a second step of determining a probability distribution corresponding to the sample values, by using a machine learning model; and a third step of sampling quantized values in a predetermined value range and determining a sample value, using the probability distribution.

According to an eighth exemplary aspect, a model learning method in a model learning device includes a step of determining a parameter set for a first machine learning model and a parameter set for a second machine learning model, so as to further reduce a combined loss function obtained by combining a first factor based on an information amount of a first sample value, and a second factor based on a difference between an input value and a second sample value, wherein the first sample value is determined by using a first probability distribution to sample quantized values in a predetermined value range, the second sample value is determined by using a second probability distribution to sample quantized values in the predetermined value range, the first machine learning model is used to determine the first probability distribution of quantized values in a predetermined value range corresponding to the input value, and the second machine learning model is used to determine the second probability distribution corresponding to the first sample value.

### Advantageous Effects of Invention

According to the above exemplary aspects, more appropriate model parameters can be acquired for the first machine learning model and the second machine learning model under a predetermined loss function. Therefore, it is possible to ensure the reproducibility of the second sample value as the output value.

### BRIEF DESCRIPTION OF THE DRAWINGS

FIG. 1 A schematic block diagram showing an information processing system according to a first configuration example.

FIG. 2 A schematic block diagram showing an information processing system according to a second configuration example.

FIG. 3 A schematic block diagram showing an information processing system according to a third configuration example.

FIG. 4 A schematic block diagram showing a configuration example of a backward pass calculation unit.

FIG. 5 A schematic block diagram showing an information processing system according to a fourth configuration example.

FIG. 6 A schematic block diagram showing an information processing system according to a fifth configuration example.

FIG. 7 A schematic block diagram showing an information processing system according to a sixth configuration example.

FIG. 8 A schematic block diagram showing a configuration example of a compression forward pass processing unit.

FIG. 9 A schematic block diagram showing a configuration example of a compression backward pass processing unit.

FIG. 10 A block diagram showing a hardware configuration example.

FIG. 11 A diagram showing an example of a neural network.

FIG. 12 A flowchart showing an example of an information processing method according to the first configuration example.

FIG. 13 A flowchart showing an example of an information processing method according to the second configuration example.

FIG. 14 A flowchart showing an example of an information processing method according to the third configuration example.

FIG. 15 A flowchart showing an example of an information processing method according to the fourth configuration example.

FIG. 16 A flowchart showing an example of an information processing method according to the fifth configuration example.

FIG. 17 A flowchart showing an example of an information processing method according to the sixth configuration example.

FIG. 18 A schematic block diagram showing a minimum configuration example of the information processing system.

FIG. 19 A schematic block diagram showing a minimum configuration example of the encoding device.

FIG. 20 A schematic block diagram showing a minimum configuration example of the decoding device.

FIG. 21 A schematic block diagram showing a minimum configuration example of the model learning device.

### EXAMPLE EMBODIMENT

Hereinafter, preferred exemplary embodiments of the present invention will be described, with reference to the drawings.

### First Exemplary Embodiment

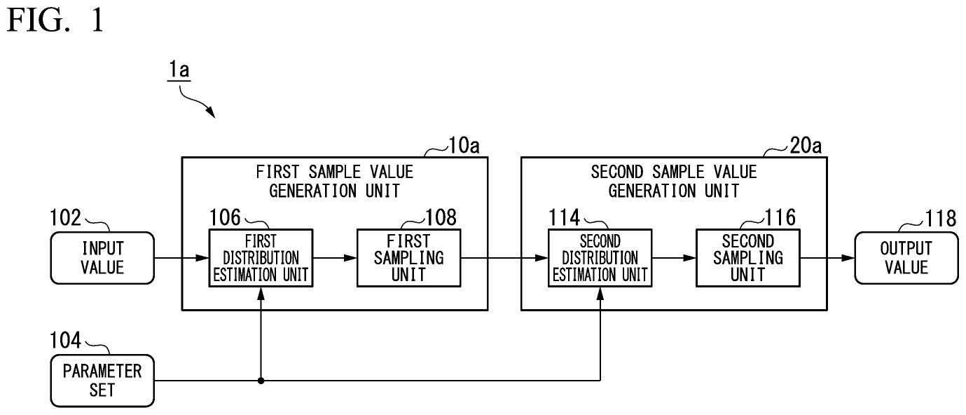

First, a first exemplary embodiment will be described. FIG. 1 is a schematic block diagram showing an information processing system 1a according to a first configuration example. The information processing system 1a includes a first sample value generation unit 10a and a second sample value generation unit 20a.

The first sample value generation unit 10a generates a sample value for an input value 102 to be input as a first sample value. The input value 102 is a single scalar value to be quantized. A first sample value is a single quantized value corresponding to the input value 102. The first sample value generation unit 10a includes a first distribution estimation unit 106 and a first sampling unit 108.

The first distribution estimation unit 106 estimates a probability distribution of quantized values corresponding to input values 102 as a first probability distribution, by using a predetermined first machine learning model. The first distribution estimation unit 106 outputs the estimated first probability distribution to the first sampling unit 108. In the first distribution estimation unit 106, among a parameter set 104, a parameter group used for calculation of the first machine learning model is preliminarily set. In the present application, a group of parameters used in machine learning model calculation may be referred to as “model parameters” or “parameter set”.

The first distribution estimation unit 106 calculates a discrete probability distribution corresponding to an input value z as the first probability distribution, using a parameter set θ, φ based on the first machine learning model. The first probability distribution is represented by the probability of each quantized value included in a predetermined value range. The quantized values are candidates for sample values. The first machine learning model is a mixture model that determines, as the first probability distribution, a probability distribution including the probability obtained by normalizing, for each quantized value n, the product of the prior probability of the quantized value n and the conditional probability of the input value z conditional on that quantized value, for example. Normalization is realized by performing division by the sum of the products for each quantized value in the value range. More specifically, the first distribution estimation unit 106 can calculate the probability p(n|z, θ, φ) of the quantized value n corresponding to the input value z as a posterior distribution shown in Equation (1).

$$\begin{matrix}[ Equation 1 ] & \\ p ( n \vert z , θ , ϕ ) = \frac{p ( z \vert n , θ ) p ( n , ϕ )}{{\sum }_{m} p ( z \vert m , θ ) p ( m , ϕ )} & ( 1 )\end{matrix}$$

p(n, φ) and p(m, φ) denote prior probabilities of quantized values n and m, respectively. However, p(n, φ) and p(m, φ) are each calculated using a predetermined continuous function under the parameter set φ. p(z|n, 0) and p(z|m, θ) denote the conditional probabilities of the input value z conditional on that the quantized values n and m are obtained, respectively. However, the conditional probabilities p(z|n, θ) and p(z|m, θ) are each calculated using a continuous function that is independent of the prior probabilities p(n, φ) and p(m, φ) under the parameter set φ. That is to say, Equation (1) shows that the probability p(n|z, θ, φ) can be obtained by normalizing the frequency obtained as the product of the prior probability (n, φ) and the conditional probability p(z|n, θ) with the sum of the frequencies of the quantized value m within the value range. A storage unit 120 may preliminarily store the conditional probabilities p(z|n, θ) and p(z|m, θ) calculated using the parameter sets φand θ, and the prior probabilities p(n, φ) and p(m, φ).

The first distribution estimation unit 106 can calculate, for example, the conditional probability p(z|n, θ), the prior probability p(n, φ), and so forth, using a Gaussian Mixture Model (GMM). The Gaussian mixture model is a mathematical model that takes a predetermined number of normal distributions (Gaussian functions) as the basic functions and represents the continuous probability distribution as a linear combination of these basic functions. Therefore, the parameter set θ, φ includes weight coefficient, mean, and variance, which are parameters of each individual normal distribution. These parameters are all represented by real numbers. Therefore, the conditional probability p(z|n, θ), the prior probability p(n, φ), and the probability for each quantized value determined using these are differentiable with respect to the above parameters. Note that the first sample value and the individual quantized values that are candidates for the first sample value do not necessarily have to be integer values. Each individual quantized value may have a different code.

The first sampling unit 108 samples one quantized value from the set value range according to the first probability distribution input from the first distribution estimation unit 106, and determines the sampled quantized value as a first sample value. The first sampling unit 108 outputs the determined first sample value to the second sample value generation unit 20a.

More specifically, the first sampling unit 108 selects one quantized value using a pseudo-random number with a probability given for each quantized value indicated by the first probability distribution.

The second sample value generation unit 20a generates a second sample value as one quantized value corresponding to the input first sample value. The second sample value generation unit 20a includes a second distribution estimation unit 114 and a second sampling unit 116.

The second distribution estimation unit 114 estimates the probability distribution corresponding to the first sample value as a second probability distribution, by using a predetermined second machine learning model. However, the estimated second probability distribution is a continuous distribution indicating the appearance probability of values in a predetermined value range. The second distribution estimation unit 114 outputs information of the estimated second probability distribution to the second sampling unit 116. The information of the second probability distribution may include, for example, parameters of the second probability distribution. In the second distribution estimation unit 114, among a parameter set 104, a parameter group used for calculation of the second machine learning model is preliminarily set. The second machine learning model may or may not be the same mathematical model as the first machine learning model. The second probability distribution can also be expressed using Gaussian. In such a case, the parameters of the second probability distribution are mean and variance.

The second sampling unit 116 samples one quantized value from the set value range according to the information of the second probability distribution input from the second distribution estimation unit 114, and determines the sampled quantized value as a second sample value. That is to say, the second sampling unit 116 selects any real number within the value range using a pseudo-random number with the probability given by the second probability distribution, and quantizes the selected real number to determine the second sample value. The second sampling unit 116 outputs the determined second sample value as an output value 118. The output destination of the output value 118 may be a functional unit or storage unit of the device that accommodates the second sampling unit 116, or may be an external device separate from this device.

Note that the first sample value generation unit 10a and the second sample value generation unit 20a may each be configured as a sample value generation unit. In such a case, the first sample value generation unit 10a and the second sample value generation unit 20a may be connected so as to be able to transmit and receive various data to and from each other, and the first sample value output by the first sample value generation unit 10a may be temporarily or permanently stored in a storage medium. The first sample value may be readable from the storage medium by the second sample value generation unit 20a.

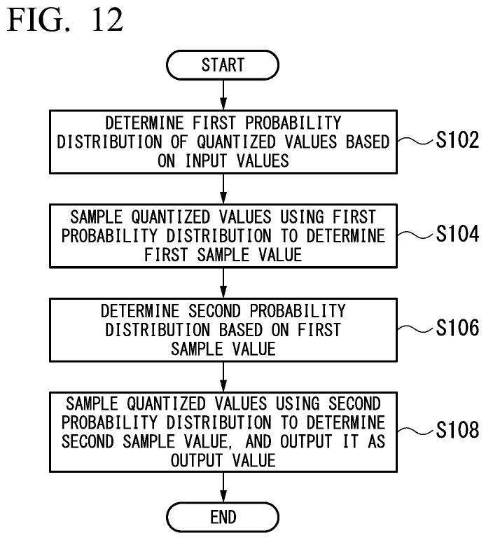

FIG. 12 is a flowchart showing an example of an information processing method according to the first configuration example.

(Step S102) The first distribution estimation unit 106 estimates the first probability distribution of quantized values on the basis of the input value 102, by using the first machine learning model.

(Step S104) The first sampling unit 108 samples one quantized value from the set value range, using the first probability distribution, and determines the sampled quantized value as a first sample value.

(Step S106) The second distribution estimation unit 114 determine a second probability distribution based on the first sample value, by using a second machine learning model.

(Step S108) The second sampling unit 116 samples one quantized value from the set value range, using the second probability distribution, and determines the sampled quantized value as a second sample value, and outputs it as output value 118. Then, the process shown in FIG. 12 ends.

Therefore, the information processing system la functions as a quantizer for acquiring the quantized value for the input value 102 as the output value 118. Also, the second sample value does not always correspond to the first sampled value, which is a code obtained from the input value 102. That is to say, the information processing system la can determine the output value 118 corresponding to the input value 102 non-deterministically. Here, “non-deterministic” can be said to mean that a processing result (output result) can be obtained with a certain degree of constraint in a certain standard (same applies hereinafter in the present application).

Targets of model learning are parameter sets of the first machine learning model and the second machine learning model. As will be described later, each parameter set includes parameters that are real numbers of a continuous function for determining probability values in a value range, so that a loss function can be differentiated with respect to these parameters. As such, these parameter sets can be optimized under a loss function determined based on at least the input values 102 and output values 118. Therefore, divergence of the second sample value being the output value 118 from the input value 102 is suppressed, and the reproducibility thereof is ensured as a result.

Next, an information processing system 1b according to a second configuration example will be described. The following description mainly focuses on points of difference from the above configuration example. Descriptions of functions and configurations common to those of the above configuration example are incorporated unless otherwise specified.

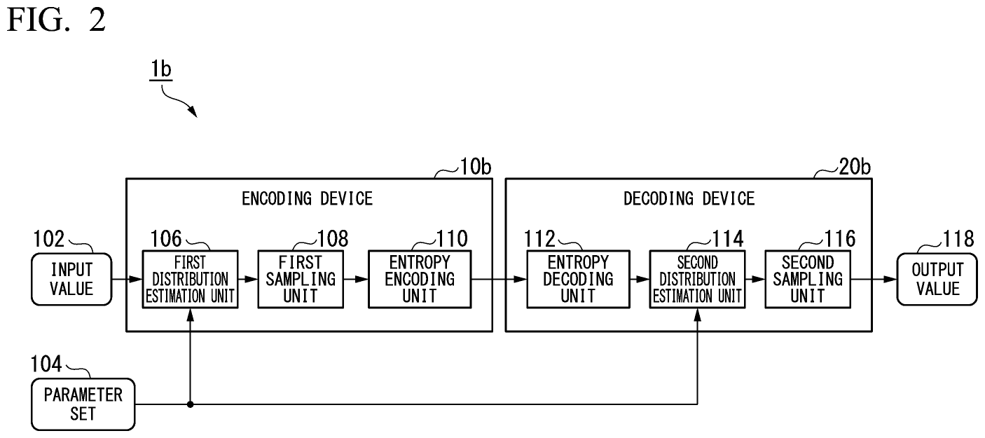

FIG. 2 is a schematic block diagram showing the information processing system 1b according to the second configuration example. The information processing system 1b includes an encoding device 10b and a decoding device 20b.

The encoding device 10b encodes an input sequence including a plurality of input values 102 to generate a code sequence. A code sequence may be referred to as a bit-stream in some cases. The encoding device 10b outputs the generated code sequence to the decoding device 20b. The encoding device 10b includes the first distribution estimation unit 106, the first sampling unit 108, and an entropy encoding unit 110.

The first distribution estimation unit 106 selects each one input value forming an input sequence and estimates the first probability distribution of the quantized value for the selected input value. Individual input values are selected from the input sequence in that order.

The first sampling unit 108 outputs the first probability distribution determined using the first probability distribution, to the entropy encoding unit 110.

The entropy encoding unit 110 accumulates the first sample values input from the first sampling unit 108 in that order, and forms a data sequence including a predetermined number of first sample values (may be referred to as the number of samples in the present application. The number of samples is a preliminarily set integer greater than or equal to 2). The entropy encoding unit 110 performs commonly known entropy encoding on the formed data sequence to generate a code sequence. The entropy encoding unit 110 outputs the generated code sequence to the decoding device 20b. As the method of entropy encoding, the entropy encoding unit 110 may use any method such as arithmetic coding, asymmetric numeral system, or Huffman coding.

The decoding device 20b decodes the code sequence and generates an output sequence that includes a plurality of output values 118. The decoding device 124 includes an entropy decoding unit 112, the second distribution estimation unit 114, and the second sampling unit 116.

The entropy decoding unit 112 performs entropy decoding on the code sequence input from the entropy encoding unit 110 to restore the data sequence. The entropy decoding unit 112 may use, as the method of entropy decoding, a decoding method corresponding to the entropy encoding method used to generate the input code sequence. The entropy decoding unit 112 outputs the restored data sequence to the second distribution estimation unit 114.

The data sequence is input from the entropy decoding unit 112 to the second distribution estimation unit 114. The second distribution estimation unit 114 selects each one first sample value forming the input data sequence, and uses the second machine learning model to determine the second probability distribution of quantized values based on the selected first sample value. Individual first sample values are selected from a data block in that order.

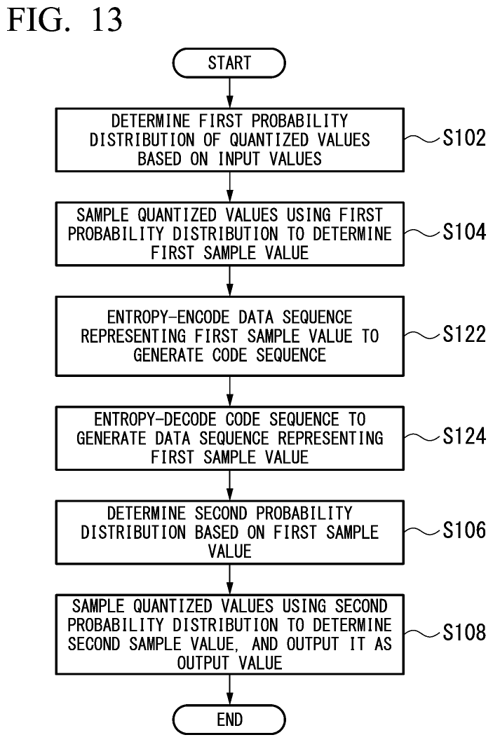

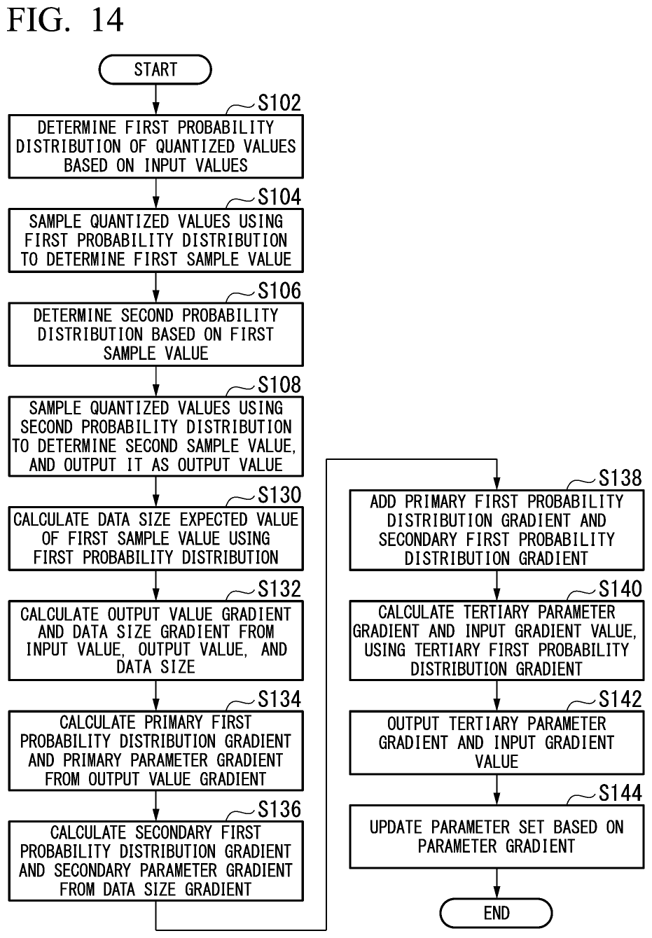

FIG. 13 is a flowchart showing an example of an information processing method according to the second configuration example. The process shown in FIG. 14 further includes Step S122 and Step S124 in addition to the processes shown in FIG. 13.

In Step S102, the first distribution estimation unit 106 selects each one input value forming the input sequence as a processing target. After the processes of Step S102 and Step S104 have been repeated a number of times corresponding to a predetermined number of samples, the process proceeds to Step S122.

(Step S122) The entropy encoding unit 110 accumulates in the order in which the first sample values of the number of samples are obtained. The entropy encoding unit 110 performs entropy encoding on the formed data sequence to generate a code sequence.

(Step S124) The entropy decoding unit 112 performs entropy decoding on the generated code sequence to restore the data sequence included in the first sample value. Then, the process proceeds to Step S106.

In Step S106, the second distribution estimation unit 114 selects each one first sample value forming the restored data sequence as a processing target. After the processes of Step S106 and Step S108 have been repeated a number of times corresponding to a predetermined number of samples, the process shown in FIG. 13 ends.

Therefore, in the information processing system 1b, non-deterministic quantization is applied to data compression. According to the encoding device 10b, a code sequence in which the amount of information is more compressed than that of the input sequence is obtained. According to the decoding device 20b, the output sequence obtained by quantizing the input sequence is reconstructed from the code sequence. Therefore, reproducibility of the output value is ensured even with data compression implemented by entropy coding.

Next, an information processing system 1c according to a third configuration example will be described. The following description mainly focuses on points of difference from the above configuration examples. Descriptions of functions and configurations common to those of the above configuration examples are incorporated unless otherwise specified.

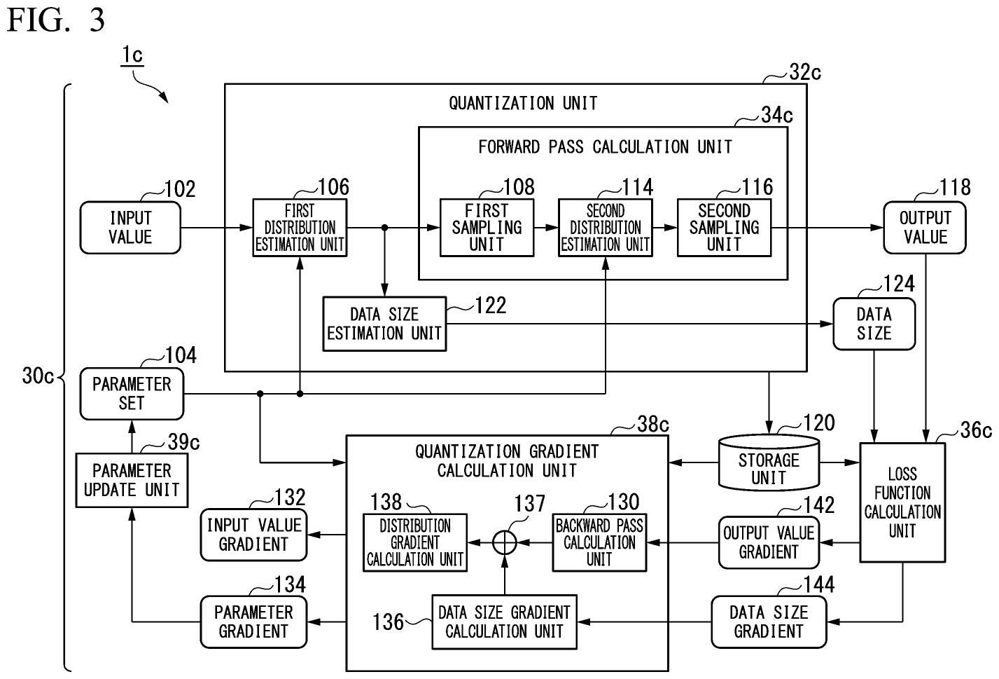

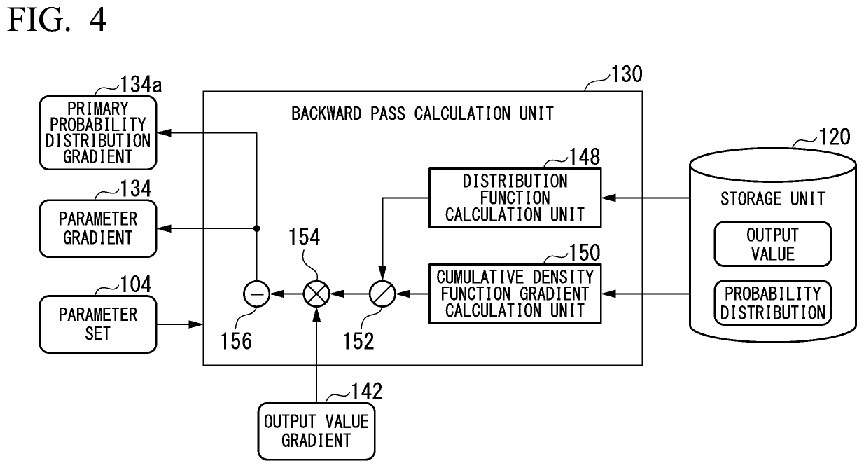

FIG. 3 is a schematic block diagram showing the information processing system 1c according to the third configuration example. The information processing system 1c includes a model learning unit 30c. The information processing system 1c may also be realized as a single model learning device.

The model learning unit 30c can perform supervised learning to determine the parameter set for each of the first machine learning model and the second machine learning model. The model learning unit 30c acquires training data including a plurality of known input values 102. The training data is also referred to as supervised data. The model learning unit 30c recursively updates (performs model learning) the parameter set for each of the first machine learning model and the second machine learning model, so as to reduce (optimize), as the entire training data, the loss function, which is determined by the magnitude of the difference between the estimated value calculated with respect to each input value 102 and the target value, and by the data size 124. In the present exemplary embodiment, as the target value with respect to each input value 102, the model learning unit 30c can use the input value 102. The input value 102 and target value correspond to an explanatory variable and an objective variable, respectively.

The loss function is a function obtained by combining a first factor indicating the magnitude of the difference between the estimated value calculated from the input value and the target value, and a second factor indicating the data size 124. The first factor is also referred to as distortion. The data size 124 indicates the amount of information of the first sample value obtained by sampling the input value.

The model learning unit 30c repeatedly updates the parameter set until the values converge. The model learning unit 30c can determine whether or not convergence has occurred, based on whether or not the amount of variation in the loss function between before and after updating has become less than or equal to the threshold value of a predetermined variation amount. The model learning unit 30c may repeat updating the parameter set a preliminarily set number of times without determining whether or not convergence has occurred.

In the present application, “optimization” includes not only obtaining an absolutely optimal parameter set but also searching for a parameter set that is as appropriate as possible. Therefore, the loss function may temporarily increase during the course of processing. As the technique for implementing optimization in updating the parameter set, a gradient method can be applied to the model learning unit 30c. The gradient method is a technique that repeats the following steps (1) to (3).

(1) Calculate the gradient for the parameter set of the loss function, (2) determine the amount of variation in the parameter set so as to further reduce the loss function, and (3) update the parameter set, using the determined variation amount.

The gradient method includes techniques such as steepest descent, stochastic gradient descent, and so forth. The processing procedure for calculating the update amount of the parameter set may be modified so as to conform to each technique. The model learning unit 30c may perform unsupervised learning to determine the parameter set for each of the first machine learning model and the second machine learning model.

The model learning unit 30c includes a quantization unit 32c, a loss function calculation unit 36c, a quantization gradient calculation unit 38c, a parameter update unit 39c, and a storage unit 120. The storage unit 120 includes a volatile memory medium such as RAM (Random Access Memory) and a non-volatile memory medium such as ROM (Read-Only Memory). The storage unit 120 stores various data used by the model learning unit 30c or generated by the model learning unit 30c. The stored data includes intermediate values calculated during the course of a series of calculations, training data, parameter set 104 set at that time, and so forth.

The quantization unit 32c quantizes an input value 102, outputs a quantized value obtained by quantization as an output value 118, and estimates a data size 124 of the first sample value.

The quantization unit 32c includes the first distribution estimation unit 106, a forward pass calculation unit 34c, and a data size estimation unit 122. The forward pass calculation unit 124 includes the first sampling unit 108, the second distribution estimation unit 114, and the second sampling unit 116. Forward pass calculation means an operation, a process, or combination thereof that performs steps common to a series of quantization processes, in that order.

The first distribution estimation unit 106 outputs the estimated first probability distribution to the data size estimation unit 122, and stores it in the storage unit 120.

The data size estimation unit 122 calculates the expected value of the data size 124 of the first sample value, based on the first probability distribution input from the first distribution estimation unit 106 and the prior probability for each quantized value. In the present application, the expected value of the data size 124 may be simply referred to as “data size” or “data size 124”. As with the first distribution estimation unit 106 and the second distribution estimation unit 114, the data size estimation unit 122 may also have a prior distribution p(n, ρ) for each quantized value n set preliminarily. The data size estimation unit 122, for example, calculates the cross entropy −EΣₙw(n)log(p(n, ρ)) between the first probability distribution w(n) and the prior distribution p(n, ρ) as the data size 124 (unit: number of bits). The first probability distribution w(n) corresponds to the above probability distribution p(n|z, θ, φ). The data size estimation unit 122 stores the estimated data size 124 in the storage unit 120.

The loss function calculation unit 36c calculates a derivative of the loss function as a gradient. The loss function gives the value of the combined function of the first factor and the second factor as described above. The first factor may be, for example, any one of a mean squared error, an absolute value sum, and so forth. The second factor may be the data size itself or a function that monotonically increases as data size increases. Combining the first factor and the second factor may be a calculation in which the loss function monotonically increases as the first factor increases, and the loss function monotonically increases as the second factor increases. Combining the first factor and the second factor may be, for example, any one of a simple sum, a weighted sum using a predetermined weighting factor for each component, and so forth.

The loss function calculation unit 36c calculates the derivative, which is a partial differential of the loss function with respect to the output value 118, as an output value gradient (gradient with respect to output value) 142, according to an equation preliminarily determined from the latest input value 102, output value 118, and data size 124 at that point in time. Moreover, the loss function calculation unit 36c calculates the derivative of the data size 124 of the loss function, as a data size gradient (gradient with respect to data size) 144, according to another equation preliminarily determined from the input value 102, output value 118, and data size 124. The loss function calculation unit 36c outputs the calculated output value gradient 142 and data size gradient 144 to the quantization gradient calculation unit 38c.

The quantization gradient calculation unit 38c calculates an input value gradient 132 and a parameter gradient 134 from the output value gradient 142 and the data size gradient 144 input from the loss function calculation unit 36c. The quantization gradient calculation unit 38c includes a backward pass calculation unit 130, a data size gradient calculation unit 136, an addition unit 137, and a distribution gradient calculation unit 138.

The backward pass calculation unit 130 calculates a primary first probability distribution gradient and a primary parameter gradient from the output value gradient 142 input from the loss function calculation unit 36c, and outputs the calculated primary first probability distribution gradient to the addition unit 137. The primary first probability distribution gradient has as its element, a derivative obtained by partially differentiating the loss function with respect to the probability of each quantized value constituting the first probability distribution. “Primary” and so forth are terms used to distinguish from “parameter gradients” calculated in other steps. The primary parameter gradient has as its element, a derivative obtained by partially differentiating the loss function with respect to the individual parameters constituting the parameter set 104. The backward pass calculation unit 130 outputs the calculated primary parameter gradient as part of the parameter gradient 134 to the parameter update unit 39c. As will be described later, the backward pass calculation unit 130 calculates a primary probability distribution gradient 134a using the output value 118 and the first probability distribution, and outputs the calculated primary probability distribution gradient 134a to the addition unit 137. A configuration example of the backward pass calculation unit 130 will be described later.

The data size gradient calculation unit 136 calculates a secondary parameter gradient and a secondary first probability distribution gradient from the data size gradient 144 input from the loss function calculation unit 36c separately from the backward pass calculation unit 130, and outputs the calculated secondary first probability distribution gradient to the addition unit 137. The data size gradient calculation unit 136 outputs the calculated secondary parameter gradient as part of the parameter gradient 134 to the parameter update unit 39c. Since the first probability distribution is input to the data size estimation unit 122, the order of operations in the data size gradient calculation unit 136 is opposite to that in the data size estimation unit 122.

The addition unit 137 adds the primary first probability distribution gradient and the secondary first probability distribution gradient respectively input from the backward pass calculation unit 130 and the data size gradient calculation unit 136 for each element, and outputs the tertiary first probability distribution gradient including the added value obtained by this addition to the distribution gradient calculation unit 138.

The distribution gradient calculation unit 138 uses the tertiary first probability distribution gradient input from the addition unit 137 to calculate the gradient of the loss function with respect to the parameter set for the first machine learning model as a tertiary parameter gradient, and outputs the calculated tertiary parameter gradient as part of the parameter gradient 134. The distribution gradient calculation unit 138 calculates the gradient of the input tertiary first probability distribution gradient with respect to the input value 102 as the input value gradient 132, and outputs the calculated input value gradient 132 to the parameter update unit 39c.

The parameter update unit 39c determines the update amount of the parameter set 104 based on the parameter gradient 134 input from the quantization gradient calculation unit 38c, and adds the determined parameter update amount to the parameter set 104 at that time, to calculate a new parameter set 104. Based on the primary parameter gradient, the secondary parameter gradient, and the tertiary parameter gradient, the parameter update unit 39c can calculate the parameter set update amounts corresponding thereto respectively.

The parameter update unit 39c stores the calculated parameter set 104 in the storage unit 120 as an updated parameter set 104. Of the updated parameter set 104, the parameter set for the first machine learning model and the parameter set for the second machine learning model are set in the first distribution estimation unit 106 and the second distribution estimation unit 114, respectively.

Note that in the present configuration example, the input value gradient 132 is not used for calculating the update amount of the parameter set 104. Therefore, the process or the configuration for calculating the input value gradient 132 may be omitted in the model learning unit 30c.

FIG. 14 is a flowchart showing an example of an information processing method according to the third configuration example. The process shown in FIG. 14 is a model learning process for calculating the parameter set for each of the first machine learning model and the second machine learning model. This process further includes Step S130 to Step S144 in addition to the processes shown in FIG. 12. The process shown in FIG. 14 is a process related to updating the parameter set once. In model learning, the process shown in FIG. 14 is typically repeated multiple times.

(Step S130) The data size estimation unit 122 calculates the expected value of the data size 124 of the first sample value, based on the first probability distribution and the prior probability for each quantized value.

(Step S132) The loss function calculation unit 36c calculates an output value gradient 142 and a data size gradient 144 from the latest input value 102, output value 118, and data size 124.

(Step S134) The backward pass calculation unit 130 calculates a primary first probability distribution gradient and a primary parameter gradient from the output value gradient 142. The backward pass calculation unit 130 outputs the primary parameter gradient as part of the parameter gradient 134 to the parameter update unit 39c.

(Step S136) The data size gradient calculation unit 136 calculates a secondary first probability distribution gradient and a secondary parameter gradient from the data size gradient 144. The data size gradient calculation unit 136 outputs the secondary parameter gradient as part of the parameter gradient 134 to the parameter update unit 39c.

(Step S138) The addition unit 137 adds the primary first probability distribution gradient and the secondary first probability distribution gradient to calculate the tertiary first probability distribution gradient.

(Step S140) The distribution gradient calculation unit 138 calculates the tertiary parameter gradient and the input value gradient 132, using the first probability distribution gradient.

(Step S142) The distribution gradient calculation unit 138 outputs the tertiary parameter gradient and the input value gradient 132 to the parameter update unit 39c.

(Step S144) The parameter update unit 39c calculates the update amount of the parameter set 104 based on the parameter gradient 134 (including the primary to tertiary parameter gradients), and adds the calculated update amount to the parameter set 104 at that point, to update this parameter set 104. The model learning unit 30c repeats the process of FIG. 14 until the amount of variation in the loss function or the parameter set 104 converges to a value less than or equal to a predetermined threshold value, and then the process of FIG. 14 ends.

Note that in the process shown in FIG. 14, the process of Step S130 can be started after the process of Step S102. The process of Step S130 may be performed in parallel with Steps S104, S106, and S108, or may be performed after Step S108.

Returning to FIG. 3, the configuration example of the backward pass calculation unit 130 will be described. The backward pass calculation unit 130 includes a distribution function calculation unit 148, a cumulative density function gradient calculation unit 150, a division unit 154, a multiplication unit 154, and an inversion unit 156.

The distribution function calculation unit 148 reads out the output value 118 and the first probability distribution stored in the storage unit 120, and determines the probability distribution function p(z′) related to the output value 118 from the output value 118 and the first probability distribution w that have been read out, using the relationship shown in Equation (2). As noted above, the output value 118 corresponds to a second sample value.

$$\begin{matrix}[ Equation 2 ] & \\ P ( {z}^{′} ) = {\sum }_{n} p ( {z}^{′} \vert n , θ ) {w}_{n} & ( 2 )\end{matrix}$$

In Equation (2), z′ indicates the output value 118. wₙ indicates the first probability distribution. The first probability distribution wₙ corresponds to the probability distribution p(n|z, θ, φ) for each quantized value mentioned above. n indicates the quantized value within the value range. That is to say, the Equation (2) indicates that the weighted sum weighted by the probability wₙ of the conditional probability p(z′|n, θ) of the predetermined output value z′ can be calculated as a probability distribution function p(z′). The conditional probability p(z′|n, θ) corresponds to the above second probability distribution where the quantized value n is given. In Equation (2), θ indicates the parameter set of the second distribution estimation unit.

The distribution function calculation unit 148 outputs the determined probability distribution function p(z′) to the division unit 152.

The cumulative density function gradient calculation unit 150 reads out the output value z′ and the first probability distribution stored in the storage unit 120, and calculates the probability distribution gradient of the cumulative density function CDF C(z′) of the probability distribution function p(z′) of the output value z′ and the parameter gradient of the CDF, from the output value z′ and the first probability distribution w that have been read out. The probability distribution gradient of CDF C(z′) is a vector containing, as elements, derivatives obtained by partially differentiating the cumulative probability forming the CDF C(z′) with respect to the probability wₙ of its quantized value n. The parameter gradient of the CDF C(z′) is a vector containing, as elements, derivatives obtained by partially differentiating the cumulative probability forming the CDF C(z′) with respect to the individual parameters of the parameter set 104. The cumulative density function gradient calculation unit 150 outputs the calculated CDF probability distribution gradient and CDF parameter gradient to the division unit 152 as a cumulative density function probability distribution gradient and a cumulative density function parameter gradient, respectively.

The division unit 152 divides the matrix element of the cumulative density function probability distribution gradient input from the cumulative density function gradient calculation unit 150 by the probability distribution function p(z′) input from the distribution function calculation unit 148, to calculate the normalized division value. The division unit 152 outputs to the multiplication unit 154 the normalized cumulative density function probability distribution gradient containing the calculated division value as an element.

The division unit 152 divides the vector element of the cumulative density function parameter gradient input from the cumulative density function gradient calculation unit 150 by the probability distribution function p(z′) input from the distribution function calculation unit 148, to calculate the normalized division value. The division unit 152 outputs to the multiplication unit 154 the normalized cumulative density function parameter gradient containing the calculated division value as an element.

The multiplication unit 154 receives input of the output value gradient 142 from the loss function calculation unit 36c, and receives input of the normalized cumulative density function probability distribution gradient and the normalized cumulative density function parameter gradient from the division unit 152. The multiplication unit 154 multiplies the output value gradient 142 by the cumulative density function probability distribution gradient to calculate a first multiplication value vector. The multiplication unit 154 multiplies the output value gradient 142 by the cumulative density function parameter gradient to calculate a second multiplication value vector. The multiplication unit 154 outputs the calculated first multiplication value vector and the second multiplication value vector to the inversion unit 156.

The inversion unit 156 inverts (negates) the polarities (positive and negative) of the first multiplication value vector and the second multiplication value vector input from the multiplication unit 154, and outputs the first multiplication value vector, the polarity of which has been inverted, as the primary probability distribution gradient 134a to the addition unit 137. The primary probability distribution gradient 134a corresponds to the gradient of the inverse function C(z′)⁻¹ of the cumulative density function C(z′) with respect to the first probability distribution wₙ. The second multiplication value vector, the polarity of which has been inverted by the inversion unit 156, corresponds to the primary parameter gradient. The inversion unit 156 outputs the primary parameter gradient as part of the parameter gradient 134 to the parameter update unit 39c.

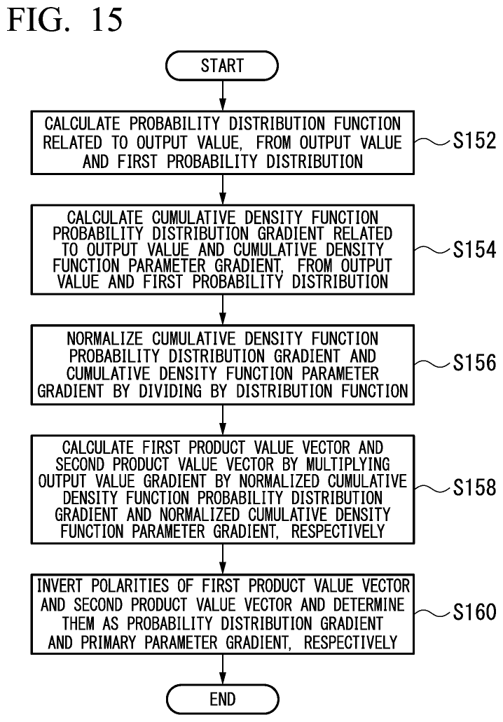

FIG. 15 is a flowchart showing an example of the backward pass calculation. The entire process of FIG. 15 corresponds to the process of Step S134 (FIG. 14).

(Step S152) The distribution function calculation unit 148 determines a probability distribution function related to the output value 118, that is, the second probability distribution function, from the output value 118 and the first probability distribution.

(Step S154) The cumulative density function gradient calculation unit 150 calculates a cumulative density function probability distribution gradient and a cumulative density function parameter gradient related to the output value 118, from the output value 118 and the first probability distribution.

(Step S156) The division unit 152 normalizes the cumulative density function probability distribution gradient and the cumulative density function parameter gradient by the probability distribution function to calculate the cumulative normalized density function probability distribution gradient and the normalized cumulative density function parameter gradient.

(Step S158) The multiplication unit 154 multiplies the output value gradient 142 by the normalized cumulative density function parameter gradient and the normalized cumulative density function parameter gradient respectively to calculate a first multiplication value vector and a second multiplication value vector.

(Step S160) The inversion unit 156 inverts the polarities of the first multiplication value vector and the second multiplication value vector, and determines them as the probability distribution gradient 134a and the primary parameter gradient, respectively. Then, the process of FIG. 15 ends.

Here, the primary probability distribution gradient 134a ∂L/∂wₙ calculated in the backward pass calculation unit 130 will be examined. As shown in Equation (3), the probability distribution gradient 134a ∂L/∂wₙ is the product of the output value gradient ∂L/∂z′ and the derivative ∂z′/∂wₙ of the probability density wₙ of the output value z′. In Equation (3), L indicates a loss function. However, the primary probability distribution gradient 134a shown in Equation (3) is based on the premise that the data size is constant.

$$\begin{matrix}[ Equation 3 ] & \\ \frac{\partial L}{\partial {w}_{n}} = \frac{\partial L}{\partial {z}^{′}} \cdot \frac{\partial {z}^{′}}{\partial {w}_{n}} & ( 3 )\end{matrix}$$

As shown in Equation (4), the parameter gradient 134a ∂L/∂θ is the product of the output value gradient ∂L/∂z′ and the derivative ∂Z/∂θ of the parameter θ of the output value z′.

$$\begin{matrix}[ Equation 3 ] & \\ \frac{\partial L}{\partial θ} = \frac{\partial L}{\partial {z}^{′}} \cdot \frac{\partial {z}^{′}}{\partial θ} & ( 3 )\end{matrix}$$

Therefore, according to the backward pass calculation unit 130, as shown in Equation (5), the gradient of the first probability distribution wₙ of the output value z′ (hereinafter, referred to as the “output value probability distribution gradient”) ∂z′/∂wₙ can be obtained, in the division unit 152, by inverting the code of the normalized cumulative density function probability distribution gradient that is calculated by normalizing the cumulative density function probability distribution gradient ∂C(z′)/∂wₙ by the probability density function p(z′). The operator “/” in the equations is a symbol representing division (the same applies hereinafter).

$$\begin{matrix}[ Equation 5 ] & \\ \frac{\partial {z}^{′}}{\partial {w}_{n}} = - ( \begin{matrix}\partial C ( {z}^{′} ) \\ ô {w}_{n}\end{matrix} ) / p ( {z}^{′} ) & ( 5 )\end{matrix}$$

Next, the parameter gradient used for updating the parameter set 0 is examined. In the present configuration example, as shown in Equation (6), the gradient of the parameter set θ of the output value z′ (hereinafter, referred to as “output value parameter gradient”) ∂z′/∂θ is obtained by inverting the code of the normalized cumulative density function parameter gradient that is calculated by normalizing the cumulative density function parameter gradient ∂C(z′)/∂θ by the probability density function p(z′).

$$\begin{matrix}[ Equation 6 ] & \\ \frac{\partial {z}^{′}}{\partial θ} = - ( \frac{\partial C ( {z}^{′} )}{\partial θ} ) / p ( {z}^{+} ) & ( 6 )\end{matrix}$$

Equation (5) and Equation (6) can be derived as described below. As mentioned above, the output value z′ is obtained by performing processes of the first distribution estimation unit 106, the first sampling unit 108, the second distribution estimation unit 114, and the second sampling unit 116 on the input value z. The output value z′ is obtained by sampling using the continuous distribution p(z′) shown in Equation (2). On the other hand, since sampling is performed using uniform random numbers (uniform random sampling), it is performed independently of the parameter set 0 and the first probability distribution wₙ. Here, if the sampling function is represented as u(θ, wₙ) (corresponding to C(z′)), the parameter gradient ∂u(θ, wₙ)/∂ of the sampling function u(θ, wₙ) and the probability density gradient ∂u(θ, wₙ)/∂wₙ of the sampling function u(θ, wₙ) are both zero.

Therefore, according to the chain rule, the relationship shown in Equation (7) holds.

$$\begin{matrix}[ Equation 7 ] & \\ 0 = \frac{\partial u}{\partial θ} = - \frac{\partial C ( {C}^{- 1} ( u ) )}{\partial θ} = \frac{\partial C ( {z}^{′} )}{\partial {z}^{′}} \frac{\partial {C}^{- 1} ( u )}{\partial θ} + \frac{\partial C ( {z}^{′} )}{\partial θ} & ( 7 )\end{matrix}$$

Moreover, even if the parameter set θ is replaced with the first probability distribution wₙ in Equation (7), the relationship shown in Equation (8) holds.

$$\begin{matrix}[ Equation 8 ] & \\ 0 = \frac{\partial u}{\partial {w}_{n}} = - \frac{\partial C ( {C}^{- 1} ( u ) )}{\partial {w}_{n}} = \frac{\partial C ( {z}^{′} )}{\partial {z}^{′}} \frac{\partial {C}^{- 1} ( u )}{{R}_{n}} + \frac{\partial C ( {z}^{′} )}{\partial {w}_{n}} & ( 8 )\end{matrix}$$

However, in Equation (7) and Equation (8), C⁻¹(u) is the inverse function of the cumulative density function C(z′). The value of the inverse function C⁻¹(u) corresponds to the output value 118 z′. Then, the gradient ∂C⁻¹(u)/∂wₙ for the probability distribution wₙ of the inverse function C⁻¹(u) and the gradient ∂C⁻¹(u)/∂θ for the parameter set correspond respectively to the gradient ∂z′/∂wₙ with respect to the probability distribution wₙ of the output value z′ and the gradient ∂z′/∂θ with respect to the probability distribution θ of the output value z′. Also, the gradient ∂C(z′)/∂z′ corresponds to p(z′). Therefore, Equation (5) and Equation (6) can be derived respectively from Equation (7) and Equation (8).

The gradients ∂C⁻¹(u)/∂wₙ and OC⁻¹(u)/∂θ correspond to the probability distribution gradient and the parameter gradient, respectively. This indicates that the loss function can be differentiated with respect to the parameter θ applied to the second distribution estimation unit 114. That is to say, according to the model learning according to the present configuration example, the parameter θ applied to the second distribution estimation unit 114 can be mathematically calculated based on the loss function. Here, the gradients ∂C⁻¹(u)/∂wₙ and ∂C⁻¹(u)/∂θ can be calculated without explicitly calculating C⁻¹(u) in model learning. Therefore, according to the present configuration example, it is possible to realize model learning based on a loss function L through simple calculations.

### Second Exemplary Embodiment

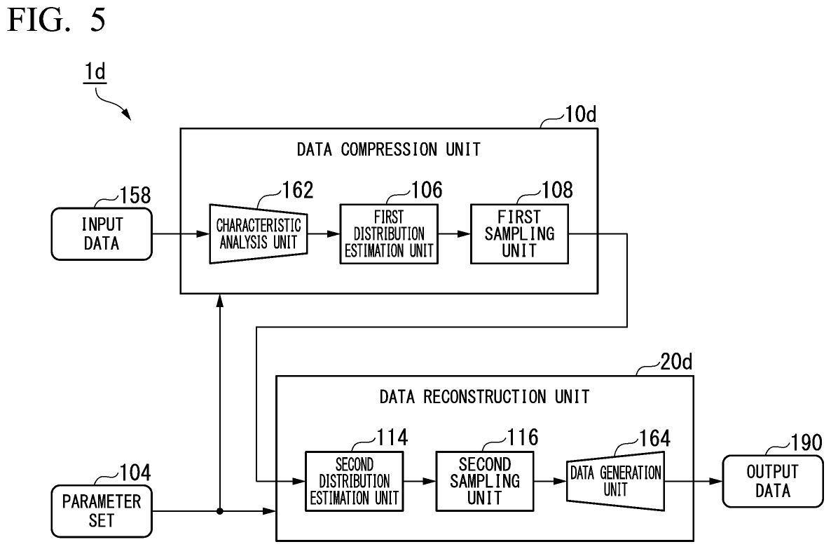

Next, a second exemplary embodiment will be described below. An information processing system 1d according to a fourth configuration example will be described. The following description mainly focuses on points of difference from the above configuration examples. Descriptions of functions and configurations common to those of the above configuration examples are incorporated unless otherwise specified. FIG. 5 is a schematic block diagram showing the information processing system 1d according to the fourth configuration example. The information processing system 1d includes a data compression unit 10d and a data reconstruction unit 20d.

The data compression unit 10d analyzes a first characteristic value indicating the characteristic transmitted in input data 158 and determines a first sample value for each of the one or more input values 102 including the first characteristic value. The data reconstruction unit 20d determines a second sample value from the determined first sample value. The data reconstruction unit 20d generates output data that transmits characteristics indicated by the second characteristic value that includes one or more determined second sample values.

The input data 158 may be data indicating physical characteristics such as image data, audio data, weather data, and so forth, or data indicating artificial information such as economic index data, price data, and so forth. The input data 158 may be data that includes a plurality of sample values and that is allowed to be irreversibly reconstructed from characteristic values expressing the characteristics when compressed. Moreover, the characteristics to be transmitted means the characteristics of all the plurality of samples forming individual input data, such as temporal change, spatial change, and statistical properties.

The data compression unit 10d includes a characteristic analysis unit 162, the first distribution estimation unit 106, and the first sampling unit 108.

The characteristic analysis unit 162 analyzes the characteristic of the input data 158 being input, using a predetermined analysis model, and determines the first characteristic value indicating the characteristic. The characteristic analysis unit 162 outputs the determined first characteristic value to the first distribution estimation unit 106. In the case where the input data 158 is image data indicating a signal value for each pixel, the characteristic analysis unit 162 analyzes the image feature amount as the first characteristic value, for example. The analysis model may be a mathematical model for calculating a predetermined type of characteristic value, or may be a machine learning model such as a neural network. The image feature amount to be analyzed may be, for example, a specific type of image feature amount such as a luminance gradient, edge distribution, or the like, or may be the output value at each node included in a predetermined layer among the layers forming a neural network. In the present application, the machine learning model used by the characteristic analysis unit 162 is referred to as “third machine learning model” to be distinguished from other machine learning models.

The first distribution estimation unit 106 takes individual element values as input values for one or more element values included in the first characteristic value, and estimates a first probability distribution of quantized values for each input value as with the first configuration example.

The data reconstruction unit 20d includes the second distribution estimation unit 114, the second sampling unit 116, and a data generation unit 164. The data generation unit 164 uses a predetermined generation model for the second characteristic value including, as its elements, one or more second sample values input from the second sampling unit 116, to generate, as output data 190, reconstructed data having the characteristic represented by the second sample value. The generation of the output data 190 from the second characteristic value performed by the data generation unit 164 corresponds to the backward pass process of the analysis from the input data 158 to the first characteristic value. The generation model may be a mathematical model for generating data having the characteristic represented by a predetermined type of characteristic value, or may be a machine learning model such as a neural network. In the present application, the machine learning model used by the data generation unit 164 is referred to as “fourth machine learning model” to be distinguished from other machine learning models.

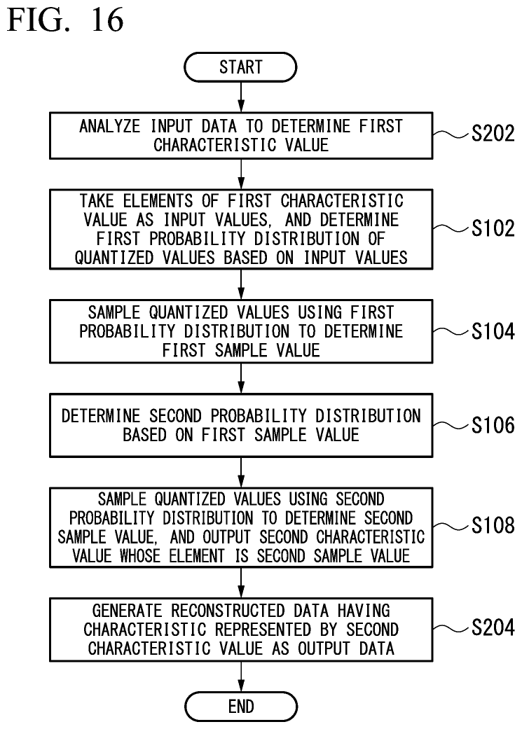

FIG. 16 is a flowchart showing an example of an information processing method according to the fourth configuration example. The process shown in FIG. 16 further includes Step S202 and Step S204 in addition to the processes shown in FIG. 12.

(Step S202) The characteristic analysis unit 162 analyzes the characteristics of the input data 158, and determines the first characteristic value indicating the characteristic. Then, the processes of Steps S102, S104, S106, and S108 are repeated a number of times corresponding to the number of input values indicating the first characteristic value, and then the process proceeds to Step S204.

(Step S204) The data generation unit 164 identifies, as second characteristic values, the predetermined number of second sample values determined in the process of Step S108, and generates, as output data 190, reconstructed data having characteristics indicated by the identified second characteristic values.

Then, the process of FIG. 16 ends.

As described above, the non-deterministic quantization implemented in the information processing system la is applied to the information processing system 1d including the characteristic analysis unit 162 and the data generation unit 164. The characteristic analysis unit 162 determines the first characteristic value indicating the characteristic of the input data 158. The first characteristic value is used as an input value to the first distribution estimation unit 106. Therefore, the output data 190 is reconstructed with a minimized loss in the characteristics of the input data 158 while performing data compression by converting the input data 158 into the first characteristic value.

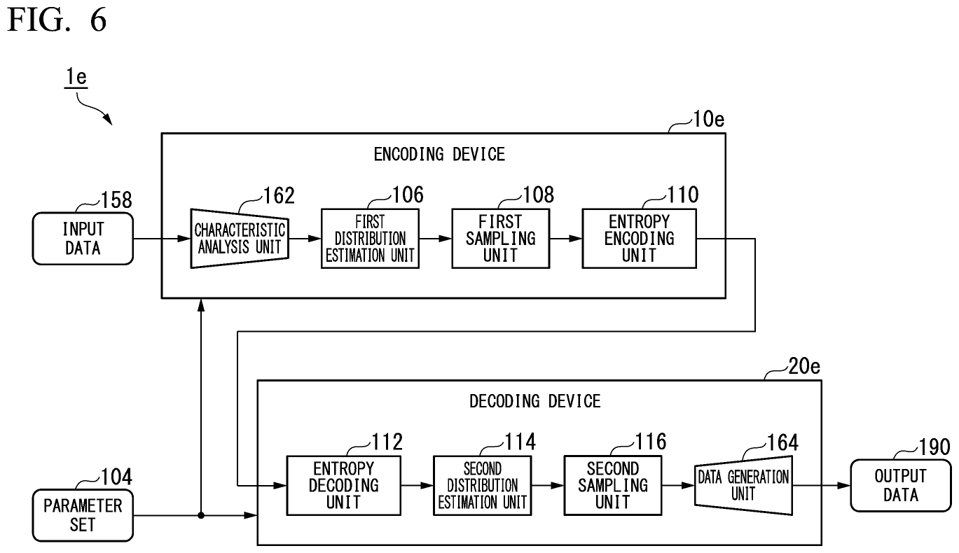

Next, an information processing system 1e according to a fifth configuration example will be described. The following description mainly focuses on points of difference from the above configuration examples. Descriptions of functions and configurations common to those of the above configuration examples are incorporated unless otherwise specified. FIG. 6 is a schematic block diagram showing the information processing system 1e according to the fifth configuration example. The information processing system 1e includes an encoding device 10e and a decoding device 20e.

The encoding device 10e encodes input data 158 to generate a code sequence. The encoding device 10e outputs the generated code sequence to the decoding device 20e. The encoding device 10e includes the characteristic analysis unit 162, the first distribution estimation unit 106, the first sampling unit 108, and the entropy encoding unit 110.

As with the second configuration example, the first sampling unit 108 outputs the first probability distribution determined using the first probability distribution to the entropy encoding unit 110.

As with the second configuration example, the entropy encoding unit 110 performs entropy encoding on data formed by the accumulation of first sample values input from the first sampling unit 108, to generate a code sequence. The entropy encoding unit 110 outputs the generated code sequence to the decoding device 20e.

The decoding device 20b decodes the code sequence and generates output data 190. The decoding device 20b includes an entropy decoding unit 112, the second distribution estimation unit 114, the second sampling unit 116, and the data generation unit 164.

As with the second configuration example, the entropy decoding unit 112 performs entropy decoding on the code sequence input from the entropy encoding unit 110 to restore the data sequence. The entropy decoding unit 112 outputs the restored data sequence to the second distribution estimation unit 114.

As with the second configuration example, the second distribution estimation unit 114 determines the second distribution estimation of quantized values, based on each first sample value forming the data sequence input from entropy decoding unit 112.

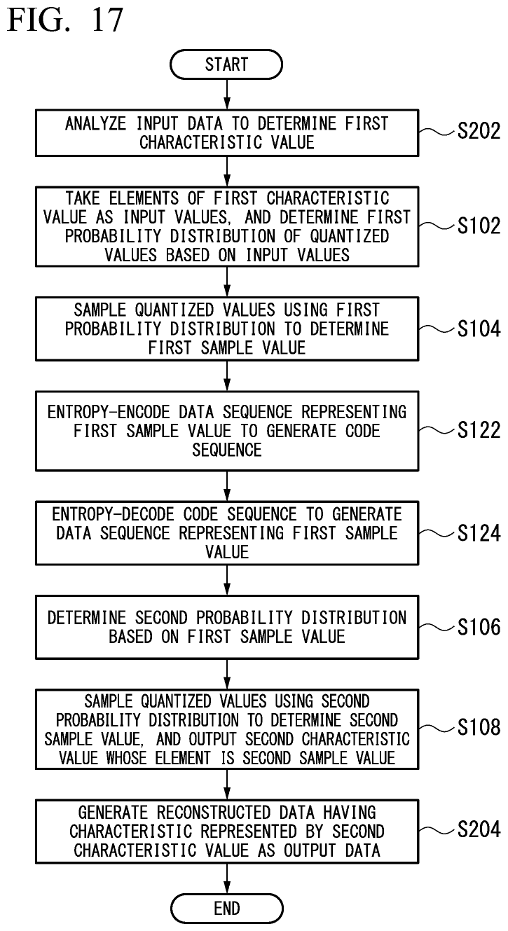

FIG. 17 is a flowchart showing an example of an information processing method according to the fifth configuration example. The process shown in FIG. 17 further includes Step 5122 and Step 5124 in addition to the processes shown in FIG. 16. The processes of Step 5122 and Step 5124 shown in FIG. 17 are the same as the processes of Step S122 and Step S124 shown in FIG. 13, and descriptions thereof are therefore omitted.

Next, an example of a neural network used as the third machine learning model and the fourth machine learning model will be described.

FIG. 11 shows a configuration example of a CNN (Convolutional Neural Network), which is a type of neural network. A CNN includes one input layer, a plurality of intermediate layers (hidden layers), and one output layer. The CNN shown in FIG. 11 includes an input layer I1, L layers (L is an integer greater than or equal to 2) of intermediate layers M1-1 to M1-L, and an output layer O1. Each layer has a predetermined number of nodes. The plurality of intermediate layers include at least one convolutional layer and one pooling layer.

Each node of the input layer I1 outputs an input value input to itself to at least one node of the next layer. In the characteristic analysis unit 162, individual sample values forming input data 158 are input to nodes corresponding to the sample values. In the data generation unit 164, individual second sample values forming the second sample value are input to the nodes corresponding to the second sample values.

Each node of the output layer 01 externally outputs an input value input from at least one node of the immediately preceding layer. In the characteristic analysis unit 162, individual first sample values forming the first characteristic value are output from the nodes corresponding to the first characteristic values. In the data generation unit 164, individual sample values forming output data 190 are output from nodes corresponding to the sample values.

The number of kernels is preliminarily set in the convolutional layer. The number of kernels corresponds to the number of kernels used for processing (for example, calculation) for each input value. The number of kernels is typically less than the number of input values. A kernel is a process unit for calculating one output value at a time. An output value calculated in one layer is used as an input value to the next layer. Kernels are also referred to as filters. A kernel size refers to the number of input values used for one process in a kernel. A kernel size is usually an integer greater than or equal to 2.

The convolutional layer performs a convolution calculation for each kernel on the input values input from the previous layer to each of the multiple nodes to calculate convolved values, and the calculated convolved values and a bias value (bias) area are added to calculate corrected values. The convolutional layer computes the function value of a predetermined activation function for the calculated corrected values and outputs the calculated output values to the next layer. One or more input values are input to each node of the convolutional layer from the immediately preceding layer, and an independent convolution coefficient is used for each input value to calculate a convolved value at each node. The convolution coefficients, bias values, and activation function parameters become part of a set of model parameters.

As the activation function, for example, a rectified linear unit, a sigmoid function, or the like may be used. The rectified linear unit is a function that determines the threshold value of an output value for an input value lower than or equal to a predetermined threshold value (for example, 0), and directly outputs an input value that exceeds the predetermined threshold value. Therefore, this threshold value can be part of a set of model parameters. Moreover, for the convolutional layer, whether or not reference to the input value from the node of the immediately preceding layer is necessary and whether or not outputting the output value to the node of the next layer is necessary, can also be part of a set of model parameters.

The pooling layer is a layer that determines one representative value from the input values input from multiple nodes in the immediately preceding layer, and has a node that outputs the determined representative value to the next layer as an output value. As the representative value, for example, a value that statistically represents a plurality of input values, such as maximum value, average value, and mode value is used. A stride is set preliminarily in the pooling layer. A stride indicates the range of mutually adjacent nodes in the immediately preceding layer on which the input value is referenced for one node. As such, a pooling layer can also be viewed as a layer that down-samples the input values from the immediately preceding layer to a lower dimension and provides the output values to the next layer.

As described above, in the fifth configuration example, non-deterministic quantization can be implemented in the information processing system le further including the entropy encoding unit 110 and the entropy decoding unit 112. According to the encoding device 10b, a code sequence in which the amount of information is more compressed than that of the input sequence is obtained. According to the decoding device 20b, the output sequence obtained by quantizing the input sequence is reconstructed from the code sequence. Therefore, the output data 190 is reconstructed with a minimized loss in the characteristics of the input data 158 even if data compression is further involved.

Next, an information processing system if according to a sixth configuration example will be described. The following description mainly focuses on points of difference from the above configuration examples. Descriptions of functions and configurations common to those of the above configuration examples are incorporated unless otherwise specified.

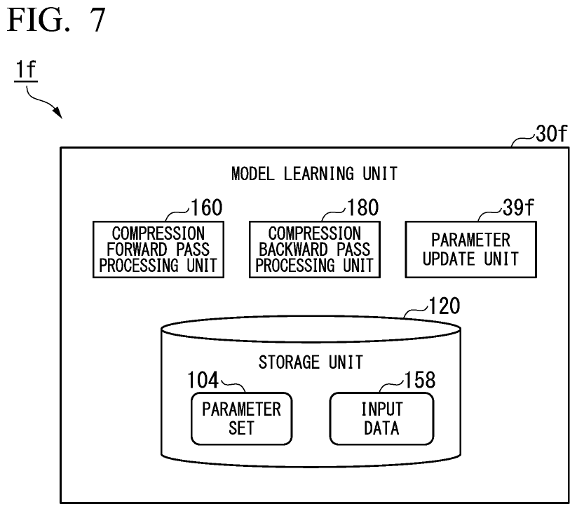

FIG. 7 is a schematic block diagram showing the information processing system if according to the sixth configuration example. The information processing system if includes a model learning unit 30f.

The model learning unit 30f acquires training data including a plurality of data pairs including known input values 158. The model learning unit 30c recursively updates the parameter set for each of the first machine learning model, the second machine learning model as well as the third machine learning model and the fourth machine learning model, so as to reduce, as the entire training data, the loss function obtained by combining the first factor indicating the magnitude of difference between the output data 190, which is an estimated value calculated for the input data 158 of each data pair, and the input data 158, which is a target value, with the second factor indicating the data size.

The model learning unit 30f includes a compression forward pass processing unit 160, a compression backward pass processing unit 180, a parameter update unit 39f, and the memory unit 120. The information processing system if may also be implemented as a single model learning device including the model learning unit 30f.

The compression forward pass processing unit 160 determines the information amount of a data sequence that is obtained by compressing the output data 190 generated by using a machine learning model under the setting of the parameter set 104 set at that time for the input data 158, and the input data 158. The compression forward pass processing unit 160 calculates a loss function 168 based on the first factor indicating the magnitude of the difference between the input data 158 and the output data 190 and the second factor indicating the determined information amount (compression forward pass process).

The compression backward pass processing unit 180 calculates a parameter gradient 134 under the setting of the parameter set 104 obtained at that time (compression backward pass process).

The parameter update unit 39f updates the parameter set 104 using the calculated parameter gradient 134 (parameter update).

The model learning unit 30f may repeat the compression forward pass process, the compression backward pass process, and the parameter update process until the parameter set 104 converges, or may repeat the processes a predetermined number of times. The parameter update unit 39f can determine whether or not the parameter set 104 5 has converged, based on whether or not the magnitude of the difference in the loss function between before and after updating has reached a predetermined threshold value.

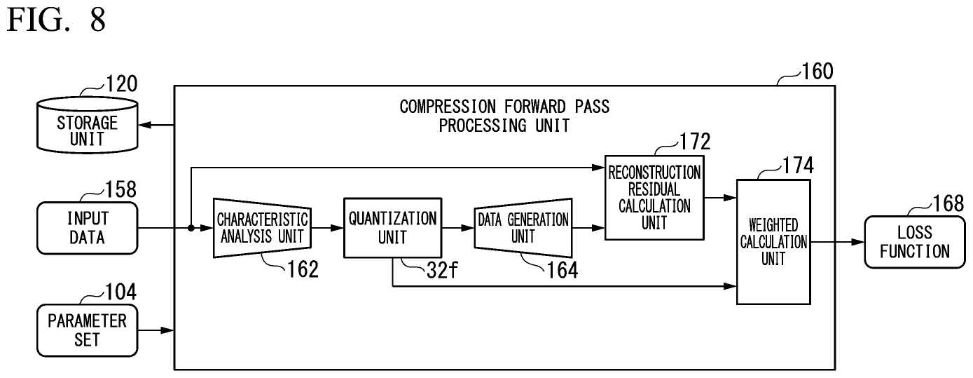

Next, a configuration example of the compression forward pass processing unit 160 will be described. FIG. 8 is a schematic block diagram showing a configuration example of the compression forward pass processing unit 160. The compression forward pass processing unit 160 includes a characteristic analysis unit 162, a quantization unit 32f, the data generation unit 164, a reconstruction residual calculation unit 172, and a weighted calculation unit 174.

As with the quantization unit 32c (see FIG. 3), the quantization unit 32f takes each element included in the first characteristic value input from the characteristic analysis unit 162 as an input value, determines a second sample for each input value, and outputs the determined second sample value to the data generation unit 164. As with the quantization unit 32c, the quantization unit 32f determines the expected value of the data size of the first sample value for each input value, and outputs the determined expected value of the data size to the weighted calculation unit 174. The description of the quantization unit 32c is used as a specific example of the process executed by the quantization unit 32f.

The reconstruction residual calculation unit 172 calculates an index value indicating the magnitude of the difference between the input data 158 input to itself and the output data 190 input from the data generation unit 164, as a reconstruction residual. In the present configuration example, the reconstruction residual corresponds to the first factor mentioned above. The reconstruction residual calculation unit 172 calculates, for example, a mean squared error (MSE) as an index value of the reconstruction residual. The mean squared error corresponds to the sample-to-sample average of the squared differences obtained by subtracting the sample values of the corresponding samples of the output data 190 from the individual sample values of the input data 158. The reconstruction residual calculation unit 172 outputs the calculated reconstruction residual (reconstruction error) to the weighted calculation unit 174.

The weighted calculation unit 174 calculates the loss function 168 based on the reconstruction residual input from the reconstruction residual calculation unit 172 and the data size input from the quantization unit 32f. The weighted calculation unit 174 determines the sum of the data sizes of the first sample values corresponding to the individual sample values of the input data 158, as the data size of the data sequence. In the present configuration example, this data size corresponds to the second factor mentioned above. The weighted calculation unit 174 calculates the weighted sum of the reconstruction residual and the data size of the data sequence, as the loss function 168.

The weighted calculation unit 174 calculates the sum of multiplication values obtained by multiplying the reconstruction residual and the data size by predetermined weighting factors, as the loss function 168. The weighted calculation unit 174 stores the calculated loss function 168 in the storage unit 120.

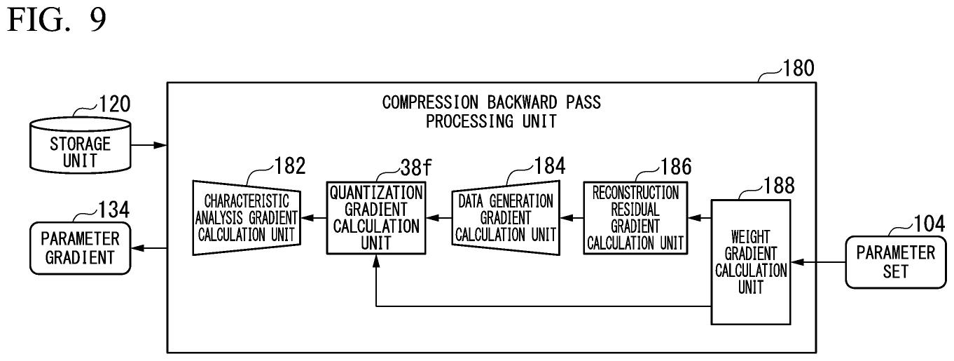

Next, a configuration example of the compression backward pass processing unit unit 180 will be described. FIG. 9 is a schematic block diagram showing a configuration example of the compression backward pass processing unit 180. The compression backward pass processing unit 180 includes a characteristic analysis gradient calculation unit 182, a quantization gradient calculation unit 38f, a data generation gradient calculation unit 184, a reconstruction residual gradient calculation unit 186, and a weight gradient calculation unit 188.

The weight gradient calculation unit 188 calculates each of a data size gradient and a reconstruction residual gradient, using a predetermined equation, based on the input data 158, the output data 190, which is reconstructed data obtained based on the input data 158, and the data size of first sample values. The reconstruction residual gradient is a derivative obtained by partially differentiating the loss function with respect to a reconstruction residual. The reconstruction residual gradient is calculated using the input data 158 and the output data 190. The data size gradient is calculated using the expected value of the data size of the first sample values. The weight gradient calculation unit 188 outputs the data size gradient to the quantization gradient calculation unit 38f and outputs the reconstruction residual gradient to the reconstruction residual gradient calculation unit 186.

Based on a predetermined relationship with individual sample values forming the output data 190 and the reconstruction residual, the reconstruction residual gradient calculation unit 186 calculates an output sample value gradient from the reconstruction residual gradient input from the weight gradient calculation unit 188. The output sample value gradient is a vector whose elements are derivatives obtained by partially differentiating the loss function with respect to individual sample values. The output sample gradient is calculated by multiplying the reconstructed residual gradient by the derivative obtained by partially differentiating the reconstruction residual with respect to the sample values. The reconstruction residual gradient calculation unit 186 outputs the calculated output sample value gradient to the data generation gradient calculation unit 184.

Based on a predetermined relationship with second sample values prescribed by the fourth machine learning model and individual sample values forming the output data 190, the data generation gradient calculation unit 184 calculates a second sample value gradient from the output sample value gradient input from the reconstruction residual gradient calculation unit 186. The second sample value gradient is calculated by multiplying the output sample value gradient by the derivative obtained by partially differentiating the sample values of the output data 190 with respect to the second sample values. The data generation gradient calculation unit 184 outputs the calculated second sample value gradient to the quantization gradient calculation unit 38f.

Moreover, based on a predetermined relationship with individual parameters prescribed by the fourth machine learning model and individual sample values forming the output data 190, the data generation gradient calculation unit 184 calculates a fourth sample value gradient from the output sample value gradient. The fourth parameter gradient is a vector whose elements are derivatives obtained by partially differentiating the loss function with respect to the individual parameters of the fourth machine learning model. The fourth parameter gradient is calculated by multiplying the output sample value gradient by a derivative obtained by partially differentiating with respect to the individual parameters of the fourth machine learning model. The data generation gradient calculation unit 184 stores the calculated fourth parameter gradient in the storage unit 120.

The quantization gradient calculation unit 38f calculates an input value gradient and a parameter gradient based on the data size gradient input from the weight gradient calculation unit 188 and the second sample value gradient input from the data generation gradient calculation unit 184. The quantization gradient calculation unit 38f outputs the calculated input value gradient to the characteristic analysis gradient calculation unit 182 as a first characteristic value gradient. The description of the quantization gradient calculation unit 38c is used as a specific example of the process executed by the quantization gradient calculation unit 38f.

The parameter gradients calculated by the quantization gradient calculation unit 38f include a first parameter gradient used for updating the parameter set of the first machine learning model and a second parameter gradient used for updating the parameter set of the second machine learning model. The first parameter gradient and the second parameter gradient are vectors including, as elements, derivatives obtained by partially differentiating the loss function with respect to the individual parameters of the first machine learning model and the second machine learning model, respectively. The quantization gradient calculation unit 38f stores the calculated first parameter gradient and second parameter gradient in the storage unit 120.

Based on a predetermined relationship with the individual parameters prescribed by the third machine learning model and the first characteristic values, the characteristic analysis gradient calculation unit 182 calculates a third parameter gradient from the first characteristic value gradient input from the quantization gradient calculation unit 38f. The third parameter gradient is a vector whose elements are derivatives obtained by partially differentiating the loss function with respect to the individual parameters of the third machine learning model. The third parameter gradient is calculated by multiplying the first characteristic value gradient by a derivative obtained by partially differentiating the first characteristic value with respect to the individual parameters of the third machine learning model. The data generation gradient calculation unit 184 stores the calculated third parameter gradient in the storage unit 120.

In parameter updating, the parameter update unit 39f reads the newly stored first parameter gradient to fourth parameter gradient from the storage unit 120, and uses the read first parameter gradient to fourth parameter gradient to update the parameter set for the first machine learning model to the fourth machine learning model, respectively. By multiplying the parameter gradient of each machine learning model by a predetermined proportionality coefficient, the parameter update unit 39f can calculate the update amount of the parameter set of the machine learning model. The parameter update unit 39f stores in the storage unit 120, a new parameter set obtained by adding the update amount calculated for each machine learning model and the current parameter set.

As described above, according to the present configuration example, based on the loss function including the reconstruction residual and the data size as the first factor and the second factor, respectively, in addition to the first machine learning model and the second machine learning model, the respective parameter sets for the third machine learning model and the fourth machine learning model can be simultaneously determined. As with the third configuration example, the loss function can be differentiated with respect to the individual parameter sets of the first machine learning model and the second machine learning model. Therefore, these parameter sets can be updated faithfully to the canonical loss function in model learning. Accordingly, since errors caused by the parameter sets of the first machine learning model and the second machine learning model are avoided or mitigated, the parameter sets of the third machine learning model and the fourth machine learning model can also be optimized in model learning. Therefore, reduction attributed to compression of the data size of the data series to which non-deterministic quantization is applied, and reduction in reconstruction error occurring in the output data 190 can both be achieved.

It should be noted that the above configuration examples may be implemented by partially modifying them, or may be configured by combining them.

For example, the above description focused primarily on the case where the model parameters of the first machine learning model and the model parameters of the second machine learning model are independent, however, the disclosure is not limited to this example. The model parameters for the second machine learning model may be common with those for the first machine learning model. In such a case, the process for updating the model parameters for the second machine learning model may be omitted.

The first sampling unit 108 and the second sampling unit 116 may each include a generator that generates random numerical values using a common pseudo-random number generation method. Each generator may have set therein common parameters (hereinafter, referred to as “random number generation parameters”) for generating random numbers using the pseudo-random numbers generation method. Moreover, in the case where the first sampling unit 108 and the second sampling unit 116 are implemented in separate devices, a parameter exchange process (not shown in the drawings) for sharing random number generation parameters may be executed.

The parameter exchange process, for example, has Step 5302 to Step 5310.

(Step S302) One of the first sampling unit 108 and the second sampling unit 116 (hereinafter, referred to as “one unit”) transmits a connection confirmation signal to the other one of them (hereinafter, referred to as “other unit”).

(Step S304) Upon receiving the connection confirmation signal from the one unit, the other unit transmits a parameter request signal to the one unit in response thereto.

(Step S306) Upon receiving the parameter request signal from the other unit, then in response thereto, the one unit transmits a random number generation parameter set in itself to the other unit.

(Step S308) Upon receiving the random number generation parameters from the one unit, the other unit sets the random number generation parameters in itself After that, the other unit transmits parameter setting completion information to the one unit.

(Step S310) Upon the one unit receiving the parameter setting completion information from the other unit, the parameter exchange process ends.

When the devices that respectively implement the first sampling unit 108 and the second sampling unit 116 start communicating with each other, the message transmitted from one device to the other device at the start of the communication may include the random number generation parameters set in the one device. In such a case, the other device may read the random number generation parameters from the message received from the one device and set the read random number generation parameters in the other device itself.

The first sample value generation unit 10a and the second sample value generation unit 20a may be configured as an integrated quantizer.

The information processing systems 1a, 1b, and the first sample value generation unit 10a, the second sample value generation unit 20a, the encoding device 10b, and the decoding device 20b, which are part thereof, or devices formed by combining these units may each include the model learning unit 30c according to the present configuration example.

The information processing systems 1c, 1d, and the data compression unit 10d, the data reconstruction unit 20d, the encoding device 10e, and the decoding device 20e, which are part thereof, or devices formed by combining these units may each include the model learning unit 30f according to the present configuration example.

The above description primarily focused on the case where the first machine learning model and the second machine learning model are both based on GMM, however, the disclosure is not limited to this example. The first machine learning model and the second machine learning model may be based on a mathematical model that can express a continuous probability density distribution using real number parameters. The first machine learning model and the second machine learning model may be neural networks.

An example is given of the case where the third machine learning model and the fourth machine learning model are both CNN, however, the disclosure is not limited to this example. The third machine learning model and the fourth machine learning model may be probabilistic neural networks such as RNN, for example. Moreover, the third machine learning model and the fourth machine learning model may be machine learning models other than neural networks, such as Bayesian networks and random forests.

### (Minimum Configuration)

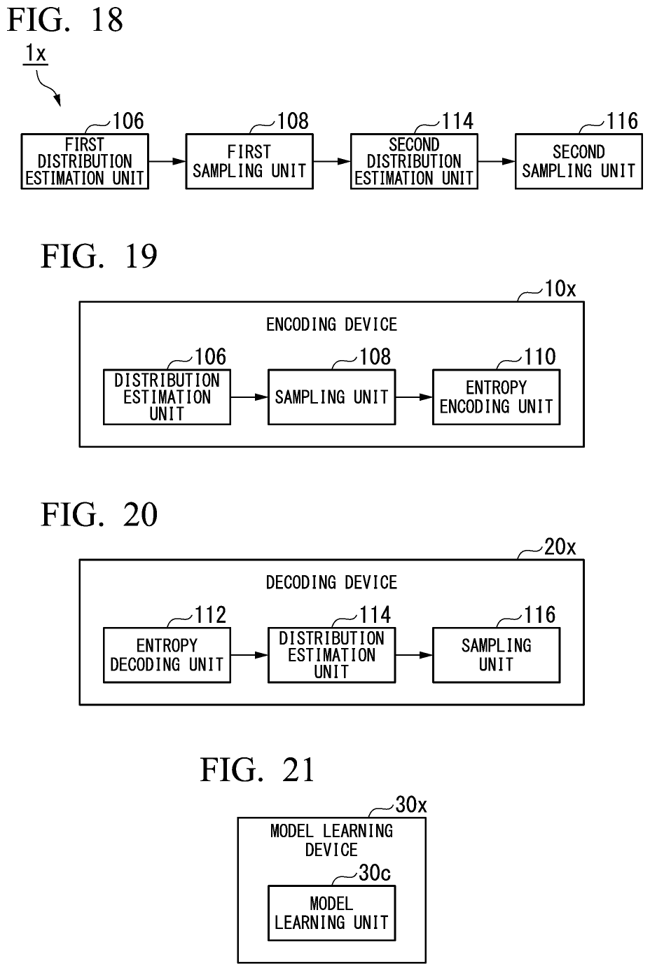

Next, a minimum configuration of the above exemplary embodiments will be described. FIG. 18 is a schematic block diagram showing a minimum configuration example of the information processing system 1x of the present application. The information processing system 1x includes the first distribution estimation unit 106 that uses a first machine learning model to determine a first probability distribution of quantized values in a predetermined value range corresponding to an input value. The information processing system 1x includes the first sampling unit 108 that uses the first probability distribution to sample the quantized values and determine a first sample value. The information processing system 1x includes the second distribution estimation unit 114 that uses a second machine learning model to determine a second probability distribution corresponding to the first sample value. The information processing system 1x includes the first sampling unit 116 that uses the second probability distribution to sample the quantized values in the value range and determine a second sample value.

FIG. 19 is a schematic block diagram showing a minimum configuration example of the encoding device 10x of the present application. The encoding device 10x includes the first distribution estimation unit 106 that uses a machine learning model to determine a probability distribution of quantized values in a predetermined value range corresponding to an input value. The encoding device 10x includes the sampling unit 108 that uses the probability distribution to sample the quantized values and determine a sample value. The encoding device 10x includes the entropy encoding device 110 that entropy-encodes a sample value sequence including a plurality of the sample values to generate a code sequence. The distribution estimation unit 106 and the sampling unit 108 have the same configurations as those of the first distribution estimation unit 106 and the first sampling unit 108, respectively.

FIG. 20 is a schematic block diagram showing a minimum configuration example of the encoding device 20x of the present application. The decoding device 20x includes the entropy decoding device 112 that entropy-decodes the code sequence to generate a sample value sequence including a plurality of sample values. The decoding device 20x includes the distribution estimation unit 114 that uses a machine learning model to determine a probability distribution corresponding to the sample value. The decoding device 20x includes the sampling unit 116 that uses the probability distribution to sample quantized values in a predetermined value range and determine a sample value. The distribution estimation unit 114 and the sampling unit 116 have the same configurations as those of the second distribution estimation unit 114 and the second sampling unit 116, respectively.

FIG. 21 is a schematic block diagram showing a minimum configuration example of the model learning device 30x. The model learning device 30x includes the model learning device 30c that determines parameters for a first machine learning model and parameters for a second machine learning model, so as to further reduce a combined loss function obtained by combining a first factor based on an information amount of a first sample value, and a second factor based on a difference between an input value and a second sample value. The first sample value is determined by using a first probability distribution to sample quantized values in a predetermined value range. The second sample value is determined by using a second probability distribution to sample quantized values in the predetermined value range. The first machine learning model is used to determine the first probability distribution of quantized values in a predetermined value range corresponding to the input value. The second machine learning model is used to determine the second probability distribution corresponding to the first sample value.

According to these configurations, it is possible to non-deterministically determine an output value 118 corresponding to an input value 102. The parameter sets for the first machine learning model and the second machine learning model are both parameters of a continuous function that defines a first probability distribution of quantized values corresponding to input values and a second probability distribution corresponding to first sample values while also being real numbers, and therefore, they can be differentiated by an output value. Accordingly, these parameter sets can be optimized under a given loss function. Therefore, divergence of the output value from the input value is suppressed, and the reproducibility thereof is ensured as a result.

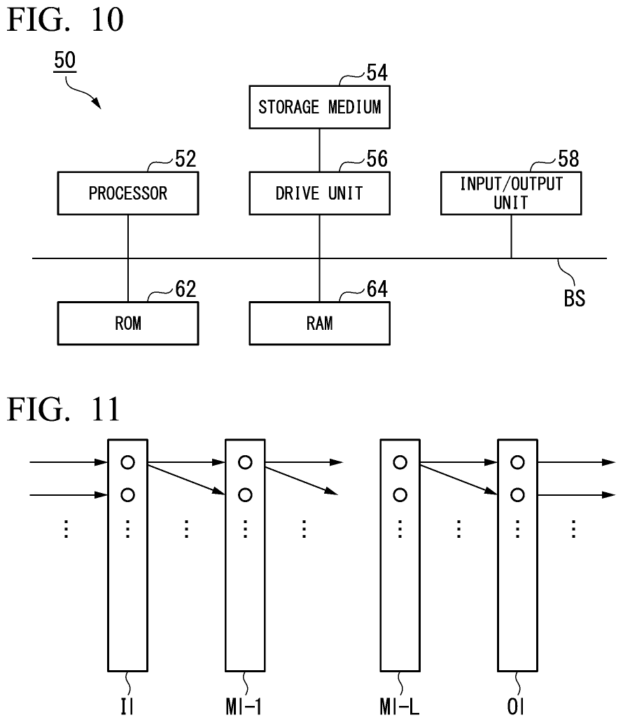

The instruments (devices) of each aspect described above may be realized by hardware including dedicated members, or may be configured as a computer including general-purpose members. A computer 50 shown in FIG. 10 includes a processor 52, a drive unit 56, an input/output unit 58, a ROM 62, and a RAM 64.

The processor 52 controls the processing for causing individual devices to exert functions thereof and controls the functions of the units that form the devices. The processor 52 is, for example, a CPU (Central Processing Unit).

The drive unit 56 includes a storage medium 54 in a detachable manner, and reads various data stored in the storage medium 54 or stores various data in the storage medium 54. The drive unit 56 is, for example, a semiconductor drive (SSD: solid state drive). The storage medium 54 is, for example, a storage medium such as RAM (Random Access Memory) or flash memory.

The input/output unit 58 inputs or outputs various data to or from other devices in a wireless or wired manner. The input/output unit 58 may be connected to other devices via a communication network so that various data can be input and output. The input/output unit 58 may be, for example, an input/output interface, a communication interface, or a combination thereof

The ROM (Read Only Memory) 62 is a storage medium that permanently stores a program that contains instructions to instruct various processes to be executed by each unit of each device, various data such as parameters for executing such processes, and various data acquired by each unit. Note that in the present application, executing a process instructed by an instruction written in a program may be expressed as “executing a program”, “program execution”, or the like.

The RAM 64 is a storage medium primarily used as a work area for the processor 52. The processor 52, upon activation thereof, records the program and parameters stored in the ROM 62 in the RAM 64. Then, the processor 52 temporarily records in the RAM 64 the calculation results obtained by executing the program, acquired data, and so forth.

Note that each of the devices mentioned above may include a computer system therein. For example, the processor 52 mentioned above can be a component of a computer system. The process of each processing described above is stored in a computer-readable recording medium in the form of a program, and the processing is performed by a computer reading and executing the program. The computer system includes software such as an OS (operating system), device drivers and utility programs, and hardware such as peripheral devices. The hardware units shown in FIG. 10 exemplify such hardware units. Moreover, the “computer-readable storage medium” refers to a portable medium such as a magnetic optical disk, ROM, RAM, and semiconductor memory, or a storage device such as a hard disk built in a computer system. Furthermore, computer-readable storage media refer to those that dynamically store programs for a short period of time, such as communication lines used for transmitting programs using networks such as the Internet and communication lines such as telephone lines. It may also include a volatile memory inside a computer system serving as a server or a client, which holds programs for a certain period of time. The program mentioned above may be a program for implementing a part of the functions described above, and may be a so-called difference file (difference program) capable of implementing the functions described above in combination with a program already recorded in a computer system.

Also, part or all of the devices in the exemplary embodiments described above may be implemented as an integrated circuit such as LSI (Large Scale Integration). Each functional block of the devices mentioned above may be individually made into a processor, or may be partially or entirely integrated into a processor. Also, the method of circuit integration is not limited to LSI, but may be realized by a dedicated circuit or a general-purpose processor. Furthermore, when an integrated circuit technology that replaces LSI appears due to the advancement of semiconductor technology, an integrated circuit based on this technology may be used.

The above exemplary embodiments may be implemented as described below.

(Supplementary Note 1) An information processing system comprising: a first distribution estimation device that determines a first probability distribution of quantized values in a predetermined value range corresponding to an input value, by using a first machine learning model; a first sampling device that samples the quantized values and determines a first sample value, using the first probability distribution; a second distribution estimation device that determines a second probability distribution corresponding to the first sample value, by using a second machine learning model; and a second sampling device that samples the quantized values in the value range and determines a second sample value, using the second probability distribution.

(Supplementary Note 2) The information processing system according to supplementary note 1 comprising: an entropy encoding device that entropy-encodes a first sample value sequence including a plurality of the first sample values to generate a code sequence; and an entropy decoding device that entropy-decodes the code sequence to generate a second sample value sequence including a plurality of the second sample values.

(Supplementary Note 3) The information processing system according to supplementary note 1 or 2, wherein the first sampling device determines, using a first pseudo-random number, any quantized value in the value range as the first sample value according to a probability indicated by the first probability distribution, and the second sampling device determines, using a second pseudo-random number, any quantized value in the value range as the second sample value according to a probability indicated by the second probability distribution.

(Supplementary Note 4) The information processing system according to any one of supplementary notes 1 to 3 comprising a model learning device that determines a parameter set for the first machine learning model and a parameter set for the second machine learning model, so as to further reduce a combined loss function obtained by combining a first factor based on an information amount of the first sample value based on the first probability distribution, and a second factor based on a difference between the input value and the second sample value.

(Supplementary Note 5) The information processing system according to any one of supplementary notes 1 to 4, wherein: the first machine learning model determines, as the first probability distribution, a probability distribution including a probability obtained by normalizing, for each quantized value, the product of a first prior probability, which is a prior probability of that quantized value, and a first conditional probability, which is a conditional probability of the input value conditional on that quantized value; the second machine learning model determines, as the second probability distribution, a probability distribution including a probability obtained by normalizing, for each quantized value, the product of a second prior probability, which is a prior probability of that quantized value, and a second conditional probability, which is a conditional probability of the first sample value conditional on that quantized value; and the first prior probability, the first conditional probability, the second prior probability, and the second conditional probability are each represented by a continuous probability density function.

(Supplementary Note 6) The information processing system according to any one of supplementary notes 1 to 5 comprising: a characteristic analysis device that analyzes input data, by using a third machine learning model and determines a first characteristic value representing a characteristic transmitted by the input data; and a data generation device that generates output data that transmits a characteristic represented by a second characteristic value, by using a fourth machine learning model, wherein the first characteristic value includes one or more of the input values, and the second characteristic value includes one or more of the second sample values.

(Supplementary Note 7) The information processing system according to supplementary note 6, further comprising a model learning device that determines a parameter set for the first machine learning model, a parameter set for the second machine learning model, a parameter set for the third machine learning model, and a parameter set for the fourth machine learning model, so as to further reduce a combined loss function value obtained by combining a first factor based on an information amount of the first sample value based on the first probability distribution, and a second factor based on a difference between the input value and the second sample value.

(Supplementary Note 8) The information processing system according to supplementary note 6 or 7, wherein each of the third machine learning model and the fourth machine learning model is a neural network.

(Supplementary Note 9) An encoding device comprising: a distribution estimation device that determines a probability distribution of quantized values in a predetermined value range corresponding to an input value, by using a machine learning model; a sampling device that samples the quantized values and determines a sample value, using the probability distribution; and an entropy encoding device that entropy-encodes a sample value sequence including a plurality of the sample values to generate a code sequence.

(Supplementary Note 10) A decoding device comprising: an entropy decoding device that entropy-decodes a code sequence to generate a sample value sequence including a plurality of sample values; a distribution estimation device that determines a probability distribution corresponding to the sample values, by using a machine learning model; and a sampling device that samples quantized values in a predetermined value range and determines a sample value, using the probability distribution. (Supplementary Note 11) A model learning device comprising: a model learning device that determines parameters for a first machine learning model and parameters for a second machine learning model, so as to further reduce a combined loss function obtained by combining a first factor based on an information amount of a first sample value, and a second factor based on a difference between an input value and a second sample value, wherein the first sample value is determined by using a first probability distribution to sample quantized values in a predetermined value range, the second sample value is determined by using a second probability distribution to sample quantized values in the predetermined value range, the first machine learning model is used to determine the first probability distribution of quantized values in a predetermined value range corresponding to the input value, and the second machine learning model is used to determine the second probability distribution corresponding to the first sample value.

(Supplementary Note 12) A storage medium having stored therein a program causing a computer to function as the information processing system according to any one of supplementary notes 1 to 8, or the device according to any one of supplementary notes 9 to 11.

(Supplementary Note 13) An information processing method in an information processing system, the method comprising: a first distribution estimation step of determining a first probability distribution of quantized values in a predetermined value range corresponding to an input value, by using a first machine learning model; a first sampling step of sampling the quantized values and determining a first sample value, using the first probability distribution; a second distribution estimation step of determining a second probability distribution corresponding to the first sample value, by using a second machine learning model; and a second sampling step of sampling the quantized values in the value range and determining a second sample value, using the second probability distribution.

(Supplementary Note 14) An encoding method in an encoding device, the method comprising: a first step of determining a probability distribution of quantized values in a predetermined value range corresponding to an input value, by using a machine learning model; a second step of sampling the quantized values and determining a sample value, using the probability distribution; and a third step of entropy-encoding a sample value sequence including a plurality of the sample values to generate a code sequence.

(Supplementary Note 15) A decoding method in a decoding device, the method comprising: a first step of entropy-decoding a code sequence to generate a sample value sequence including a plurality of sample values; a second step of determining a probability distribution corresponding to the sample values, by using a machine learning model; and a third step of sampling quantized values in a predetermined value range and determining a sample value, using the probability distribution.

(Supplementary Note 16) A model learning method in a model learning device, the method comprising a step of determining a parameter set for a first machine learning model and a parameter set for a second machine learning model, so as to further reduce a combined loss function obtained by combining a first factor based on an information amount of a first sample value, and a second factor based on a difference between an input value and a second sample value, wherein the first sample value is determined by using a first probability distribution to sample quantized values in a predetermined value range, the second sample value is determined by using a second probability distribution to sample quantized values in the predetermined value range, the first machine learning model is used to determine the first probability distribution of quantized values in a predetermined value range corresponding to the input value, and the second machine learning model is used to determine the second probability distribution corresponding to the first sample value.

Although preferred embodiments of the present invention have been described above, the present invention is not limited to these embodiments and modified examples thereof Additions, omissions, substitutions of and other changes in the configurations are possible without departing from the gist of the present invention.

Furthermore, the invention is not limited by the foregoing description, but only by the appended claims.

### INDUSTRIAL APPLICABILITY

According to the information processing system, the encoding device, the decoding device, the model learning device, the encoding method, the decoding method, the model learning method, and the program, it is possible to non-deterministically determine an output value corresponding to an input value. The parameter sets for the first machine learning model and the second machine learning model are both parameters of a continuous function that defines a first probability distribution of quantized values corresponding to input values and a second probability distribution corresponding to first sample values while also being real numbers, and therefore, they can be differentiated by an output value. Accordingly, these parameter sets can be optimized under a given loss function. Therefore, divergence of the output value from the input value is suppressed, and the reproducibility thereof is ensured as a result.

### REFERENCE SIGNS LIST

1a, 1b, 1c, 1d, 1e, 1f, 1x Information processing system
10a First sample value generation unit (first sample value generation device)
10b, 10e, 10x Encoding device
10d Data compression unit (data compression device)
20a Second sample value generation unit (second sample value generation device)
20b, 20e, 20x Decoding device
20d Data reconstruction unit (data reconstruction device)
30c, 30f Model learning unit (model learning device)
30x Model learning device
32c Quantization unit (quantization device)
36c Loss function calculation unit (loss function calculation device)
38c, 38f Quantization gradient calculation unit (quantization gradient calculation device)
39c, 39f Parameter update unit (parameter update device)

### 52 Processor

54 Storage medium
56 Drive unit
58 Input/output unit

### 62 ROM

### 64 RAM

106 First distribution estimation unit
108 First sampling unit (first sampling device)
110 Entropy encoding unit (entropy encoding device)
112 Entropy decoding unit (entropy decoding device)
114 Second distribution estimation unit (second distribution estimation device)
116 Second sampling unit (second sampling device)
120 Storage unit (storage device)
122 Data size estimation unit (data size estimation device)
130 Forward pass calculation unit (forward pass calculation device)
136 Data size gradient calculation unit (data size gradient calculation device)
137 Addition unit (addition device)
138 Distribution gradient calculation unit (distribution gradient calculation device)
148 Distribution function calculation unit (distribution function calculation device)
150 Cumulative density function gradient calculation unit (cumulative density function gradient calculation device)
160 Compression forward pass processing unit (compression forward pass processing device)
162 Characteristic analysis unit (characteristic analysis device)
164 Data generation unit (data generation device)
172 Reconstruction residual calculation unit (reconstruction residual calculation device)
174 Weighted calculation unit (weighted calculation device)
180 Compression backward pass processing unit (compression backward pass processing device)
182 Characteristic analysis gradient calculation unit (characteristic analysis gradient calculation device)
184 Data generation gradient calculation unit (data generation gradient calculation device)
186 Reconstruction residual gradient calculation unit (reconstruction residual gradient calculation device)
188 Weight gradient calculation unit (weight gradient calculation device)

What is claimed is:

1. An information processing system comprising:
at least one memory configured to store instructions; and
at least one processor configured to execute the instructions to:
determine a first probability distribution of quantized values in a predetermined value range corresponding to an input value, by using a first machine learning model;
sample the quantized values and determine a first sample value, using the first probability distribution;
determine a second probability distribution corresponding to the first sample value, by using a second machine learning model; and
sample the quantized values in the value range and determine a second sample value, using the second probability distribution.

2. The information processing system according to claim 1 comprising, wherein:
the at least one processor is further configured to execute the instructions to:
entropy-encode a first sample value sequence including a plurality of the first sample values to generate a code sequence; and
entropy-decode the code sequence to generate a second sample value sequence including a plurality of the second sample values.

3. The information processing system according to claim 1, wherein:
the at least one processor is configured to execute the instructions to:
determine, using a first pseudo-random number, any quantized value in the value range as the first sample value according to a probability indicated by the first probability distribution, and
determine, using a second pseudo-random number, any quantized value in the value range as the second sample value according to a probability indicated by the second probability distribution.

4. The information processing system according to claim 1, wherein:
the at least one processor is further configured to execute the instructions to:
determine a parameter set for the first machine learning model and a parameter set for the second machine learning model, so as to further reduce a combined loss function obtained by combining a first factor based on an information amount of the first sample value based on the first probability distribution, and a second factor based on a difference between the input value and the second sample value.

5. The information processing system according to claim 1, wherein:
the at least one processor is further configured to execute the instructions to:
determine, as the first probability distribution, a probability distribution including a probability obtained by normalizing, for each quantized value, the product of a first prior probability, which is a prior probability of that quantized value, and a first conditional probability, which is a conditional probability of the input value conditional on that quantized value; and
determine, as the second probability distribution, a probability distribution including a probability obtained by normalizing, for each quantized value, the product of a second prior probability, which is a prior probability of that quantized value, and a second conditional probability, which is a conditional probability of the first sample value conditional on that quantized value; value, and
the first prior probability, the first conditional probability, the second prior probability, and the second conditional probability are each represented by a continuous probability density function.

6. The information processing system according to claim 1, wherein:
the at least one processor is further configured to execute the instructions to:
analyze input data, by using a third machine learning model and determine a first characteristic value representing a characteristic transmitted by the input data; and
generate output data that transmits a characteristic represented by a second characteristic value, by using a fourth machine learning model, wherein
the first characteristic value includes one or more of the input values, and
the second characteristic value includes one or more of the second sample values.

7. The information processing system according to claim 6, wherein:
the at least one processor is further configured to execute the instructions to:
determine a parameter set for the first machine learning model, a parameter set for the second machine learning model, a parameter set for the third machine learning model, and a parameter set for the fourth machine learning model, so as to further reduce a combined loss function value obtained by combining a first factor based on an information amount of the first sample value based on the first probability distribution, and a second factor based on a difference between the input value and the second sample value.

8. The information processing system according to claim 6, wherein each of the third machine learning model and the fourth machine learning model is a neural network.

9-11. (canceled)

12. A non-transitory storage medium having stored therein a program causing a computer to perform processes as the information processing system, the processes comprising:
determining a first probability distribution of quantized values in a predetermined value range corresponding to an input value, by using a first machine learning model;
sampling the quantized values and determining a first sample value, using the first probability distribution;
determining a second probability distribution corresponding to the first sample value, by using a second machine learning model; and
sampling the quantized values in the value range and determining a second sample value, using the second probability distribution.

13. An information processing method in an information processing system, the method comprising:
determining a first probability distribution of quantized values in a predetermined value range corresponding to an input value, by using a first machine learning model;
sampling the quantized values and determining a first sample value, using the first probability distribution;
determining a second probability distribution corresponding to the first sample value, by using a second machine learning model; and
sampling the quantized values in the value range and determining a second sample value, using the second probability distribution.

14-16. (canceled)
